(19) United States
(12) Patent Application Publication
(10) Pub. No.: US 2020/0062996 A1
(43) Pub. Date: Feb. 27, 2020

(54) LAMINATE

(71) Applicant: DAICEL CORPORATION, Osaka-shi, Osaka (JP)

(72) Inventor: Shinji KIKUCHI, Himeji-shi (JP)

(73) Assignee: DAICEL CORPORATION, Osaka-shi, Osaka (JP)

(21) Appl. No.: 16/604,748

(22) PCT Filed: Nov. 22, 2017
(86) PCT No.: PCT/JP2017/042028

§ 371 Date: Oct. 11, 2019

(30) Foreign Application Priority Data
Apr. 12, 2017 (JP) 2017-079165

(51) Int. Cl. C09D 183/06; C09D 5/00; C09D 7/62; C09D 133/04; B32B 27/06

(52) U.S. Cl. CPC C09D 183/06; C09D 5/002; C08G 77/80; C09D 133/04; B32B 27/06; C09D 7/62

(57) ABSTRACT

An object of the present invention is to provide a laminate having a good appearance, such as surface smoothness (thickness uniformity); high surface hardness; recoatability that enables the functional layer to be provided on the hard coat layer; and a function, such as scratch resistance and stain repellency. The present invention relates to a laminate including a laminated portion constituted of two or more layers including a hard coat layer and a functional layer in contact with the hard coat layer, and a substrate in contact with the hard coat layer, the functional layer being the outermost surface of the laminate: wherein the hard coat layer is a cured product layer of a curable composition containing a polyorganosilsesquioxane and silica particles, the silica particles including a group containing a (meth)acryloyl group on the surface.

### TECHNICAL FIELD

The present invention relates to a laminate including a hard coat layer and a functional layer. The present application claims priority to JP 2017-079165 filed to Japan on Apr. 12, 2017, content of which is incorporated herein.

### BACKGROUND ART

To date, a hard coat film including a hard coat layer on one side or both sides of a substrate, in which the hard coat layer surface has a pencil hardness of approximately 3H, has been distributed. An UV acrylic monomer is mainly used as a material for forming the hard coat layer in such a hard coat film (for example, see Patent Document 1).

To impart functions, such as scratch resistance, stain repellency, and antireflective properties, to the hard coat layer, a functional layer having these functions is typically provided on the hard coat layer. In addition, in the hard coat layer in which the UV acrylic monomer described above is used, a leveling agent, such as a silicone-based or fluorine-based leveling agent, is typically used to smooth the surface and improve the appearance.

### CITATION LIST

### Patent Document

Patent Document 1: JP 2009-279840 A

### SUMMARY OF INVENTION

### Technical Problem

However, the hard coat layer in which the UV acrylic monomer described above is used cannot yet be said to have sufficient surface hardness. A hard coat layer having a pencil hardness of approximately 5H and a higher surface hardness is required. In addition, a hard coat layer in which a leveling agent, such as a silicone-based or fluorine-based leveling agent, is used has problems that if a functional layer is provided on the hard coat layer, the adhesion between the hard coat layer and the functional layer is weak, and peeling of the functional layer may occur, and the hard coat layer does not have what is called recoatability.

Accordingly, an object of the present invention is to provide a laminate having a good appearance, such as surface smoothness (thickness uniformity); high surface hardness; recoatability that enables the functional layer to be provided on the hard coat layer with good adhesion; and a function, such as scratch resistance and stain repellency.

### Solution to Problem

The present inventor found that use of a curable composition including a polyorganosilsesquioxane including a silsesquioxane constituent unit (unit structure) containing an epoxy group, and silica particles including a group containing a (meth)acryloyl group on the surface, as a curable composition for forming a hard coat layer, can provide a laminate having a good appearance, such as surface smoothness (thickness uniformity), high surface hardness, recoatability, and a function, such as scratch resistance and stain repellency.

That is, an embodiment of the present invention provides a laminate including a laminated portion constituted of two or more layers including a hard coat layer and a functional layer in contact with the hard coat layer, and a substrate in contact with the hard coat layer, the functional layer being the outermost surface of the laminate:

wherein the hard coat layer is a cured product layer of a curable composition containing a polyorganosilsesquioxane described below and silica particles, the silica particles including a group containing a (meth)acryloyl group on the surface: the polyorganosilsesquioxane includes a constituent unit represented by Formula (1) below; a molar ratio of constituent units represented by Formula (I) below to constituent units represented by Formula (II) below [constituent units represented by Formula (I)/constituent units represented by Formula (II)] is 5 or greater; a ratio of constituent units represented by Formula (1) below and constituent units represented by Formula (4) below relative to a total amount of siloxane constituent units (100 mol %) is from 55 to 100 mol %; a number average molecular weight is from 1000 to 3000; and a molecular weight dispersity (weight average molecular weight/number average molecular weight) is from 1.0 to 3.0:

[Chem. 1]

[R¹SiO_{3/2}] (1)

in Formula (1), R¹ represents a group containing an epoxy group:

[Chem. 2]

[R^{a}SiO_{3/2}] (I)

in Formula (I), R^{a} represents a group containing an epoxy group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom:

[Chem. 3]

[R^{b}SiO_{2/2}(OR^{c})] (II)

in Formula (II), R^{b} represents a group containing an epoxy group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; and R^{c} represents a hydrogen atom or an alkyl group having from 1 to 4 carbons; and

[Chem. 4]

[R¹SiO_{2/2}(OR^{c})] (4)

in Formula (4), R¹ is the same as in Formula (1); and R^{c} is the same as in Formula (II).

In the laminate according to an embodiment of the present invention, the polyorganosilsesquioxane preferably further includes a constituent unit represented by Formula (2) below:

[Chem. 5]

[R²SiO_{3/2}] (2)

in Formula (2), R² represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group.

In the laminate according to an embodiment of the present invention, R¹ in the polyorganosilsesquioxane is preferably a group represented by Formula (1a) below, a group represented by Formula (1b) below, a group represented by Formula (1c) below, or a group represented by Formula (1d) below:

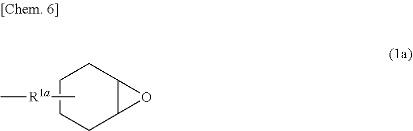

in Formula (1a), R^{1a} represents a linear or branched alkylene group;

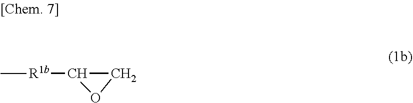

in Formula (1b), R^{1b} represents a linear or branched alkylene group:

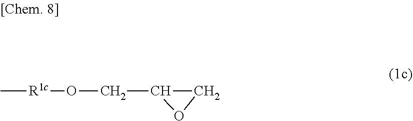

in Formula (1c), R^{1c} represents a linear or branched alkylene group; and

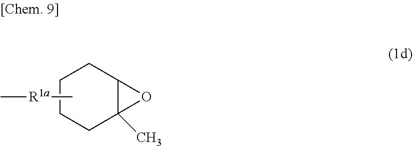

in Formula (1d), R^{1d} represents a linear or branched alkylene group.

In the laminate according to an embodiment of the present invention, R² in the polyorganosilsesquioxane is preferably a substituted or unsubstituted aryl group.

In the laminate according to an embodiment of the present invention, the curable composition preferably includes an epoxy compound other than the polyorganosilsesquioxane.

In the laminate according to an embodiment of the present invention, the curable composition preferably includes a photocationic polymerization initiator.

In the laminate according to an embodiment of the present invention, a thickness of the hard coat layer is preferably from 1 to 100 μm.

In the laminate according to an embodiment of the present invention, a thickness of the functional layer is preferably from 0.1 to 50 μm.

The laminate according to an embodiment of the present invention preferably has a total thickness of 10 to 1000 μm.

### Advantageous Effects of Invention

The laminate according to an embodiment of the present invention has a good appearance, such as surface smoothness (thickness uniformity); high surface hardness: recoatability that enables the functional layer to be provided on the hard coat layer with good adhesion; and a function, such as scratch resistance and stain repellency.

### BRIEF DESCRIPTION OF DRAWINGS

FIG. 1 is a cross-sectional conceptual diagram illustrating an example of an aspect of the laminate according to an embodiment of the present invention.

### DESCRIPTION OF EMBODIMENTS

### Laminate

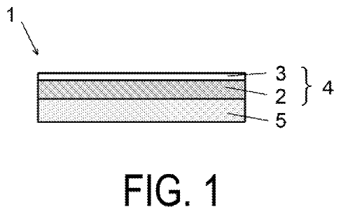

FIG. 1 is a cross-sectional conceptual diagram illustrating an example of an aspect of the laminate according to an embodiment of the present invention. In FIG. 1, the laminate 1 includes a laminated portion 4 constituted of two or more layers including a hard coat layer 2 and a functional layer 3 in contact with the hard coat layer 2, and a substrate 5 in contact with the hard coat layer 2, the functional layer 3 being the outermost surface of the laminate 1. The hard coat layer 2 is a cured product layer of a curable composition for forming the hard coat layer described later that includes a polyorganosilsesquioxane and silica particles, the silica particles including a group containing a (meth)acryloyl group on the surface.

### Hard Coat Layer

The hard coat layer in an embodiment of the present invention is a cured product layer of a curable composition for forming the hard coat layer, the cured product layer including as essential components a polyorganosilsesquioxane and silica particles, the silica particles including a group containing a (meth)acryloyl group on the surface. The laminate according to an embodiment of the present invention includes the hard coat layer described above, thereby having a good appearance, such as surface smoothness (thickness uniformity), high surface hardness, and recoatability.

### Curable Composition for Forming Hard Coat Layer

The curable composition for forming the hard coat layer includes, as essential components, a polyorganosilsesquioxane described below and silica particles, the silica particles including a group containing a (meth)acryloyl group on the surface. The curable composition for forming the hard coat layer may further include an additional component, such as a photocationic polymerization initiator, and a cationically curable compound (which may be referred to as an “additional cationically curable compound”) other than the silica particles and the polyorganosilsesquioxane, which will be described later.

### Polyorganosilsesquioxane

The polyorganosilsesquioxane (silsesquioxane) includes a constituent unit represented by Formula (1) below; wherein a molar ratio of constituent units represented by Formula (I) below (which may be referred to as “T3 form”) to constituent units represented by Formula (II) below (which may be referred to as “T2 form”) [constituent units represented by Formula (I)/constituent units represented by Formula (II); which may be described as “T3 form/T2 form” ] is 5 or greater; a ratio (total amount) of constituent units represented by Formula (I) below and constituent units represented by Formula (4) described later relative to a total amount of siloxane constituent units (100 mol %) is from 55 to 100 mol %: a number average molecular weight is from 1000 to 3000; and a molecular weight dispersity [weight average molecular weight/number average molecular weight] is from 1.0 to 3.0:

[Chem. 10]

[R¹SiO_{3/2}] (1)

[Chem. 11]

[R^{a}SiO_{3/2}] (I)

[Chem. 12]

[R^{b}SiO₂(OR^{c})] (II)

The constituent unit represented by Formula (1) above is a silsesquioxane constituent unit (what is called a T unit) generally represented by [RSiO_{3/2}]. Here, R in the above formula represents a hydrogen atom or a monovalent organic group and is also the same below. The constituent unit represented by Formula (1) above is formed by hydrolysis and condensation reactions of a corresponding hydrolyzable trifunctional silane compound (specifically, a compound represented by Formula (a) described later).

R¹ in Formula (I) represents a group (monovalent group) containing an epoxy group. That is, the polyorganosilsesquioxane is a cationically curable compound (cationically polymerizable compound) including at least an epoxy group in the molecule. Examples of the group containing an epoxy group include well known or commonly used groups including an oxirane ring and are not particularly limited, but in terms of curability of the curable composition, and surface hardness and heat resistance of the cured product, a group represented by Formula (1a) below, a group represented by Formula (1b) below, a group represented by Formula (1c) below, and a group represented by Formula (1d) below are preferred, a group represented by Formula (1a) below and a group represented by Formula (1c) below are more preferred, and a group represented by Formula (1a) below is even more preferred:

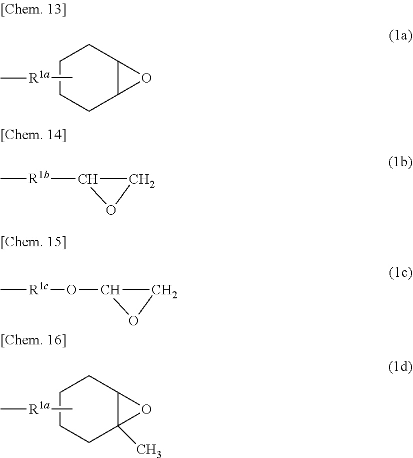

In Formula (1a) above, R^{1a} represents a linear or branched alkylene group. Examples of the linear or branched alkylene group include linear or branched alkylene groups having from 1 to 10 carbons, such as a methylene group, a methyl methylene group, a dimethyl methylene group, an ethylene group, a propylene group, a trimethylene group, a tetramethylene group, a pentamethylene group, a hexamethylene group, and a decamethylene group. Among them, in terms of surface hardness and curability of the cured product. R^{1a} is preferably a linear alkylene group having from 1 to 4 carbons and a branched alkylene group having 3 or 4 carbons, and more preferably an ethylene group, a trimethylene group, and a propylene group, and even more preferably an ethylene group and a trimethylene group.

In Formula (1b) above, R^{1b} represents a linear or branched alkylene group, and the same groups as R^{1a} are exemplified. Among them, in terms of surface hardness and curability of the cured product, R^{1b} is preferably a linear alkylene group having from 1 to 4 carbons and a branched alkylene group having 3 or 4 carbons, and more preferably an ethylene group, a trimethylene group, and a propylene group, and even more preferably an ethylene group and a trimethylene group.

In Formula (1c) above, R^{1c} represents a linear or branched alkylene group, and the same groups as R^{1a} are exemplified. Among them, in terms of surface hardness and curability of the cured product, R^{1c} is preferably a linear alkylene group having from 1 to 4 carbons and a branched alkylene group having 3 or 4 carbons, and more preferably an ethylene group, a trimethylene group, and a propylene group, and even more preferably an ethylene group and a trimethylene group.

In Formula (1d) above, R^{1d} represents a linear or branched alkylene group, and the same groups as R^{1a} are exemplified. Among them, in terms of surface hardness and curability of the cured product, R^{1d} is preferably a linear alkylene group having from 1 to 4 carbons and a branched alkylene group having 3 or 4 carbons, and more preferably an ethylene group, a trimethylene group, and a propylene group, and even more preferably an ethylene group and a trimethylene group.

R¹ in Formula (I) is preferably a group represented by Formula (1a) above, and in particular, a group in which R^{1a} is an ethylene group (in particular, 2-(3,4-epoxycyclohexyl)ethyl group) is preferable.

The polyorganosilsesquioxane may include only one type of constituent unit represented by Formula (1) above or may include two or more types of constituent units represented by Formula (1) above.

The polyorganosilsesquioxane may also include a constituent unit represented by Formula (2) below, in addition to the constituent unit represented by Formula (I) above, as the silsesquioxane constituent unit [RSiO_{3/2}].

[Chem. 17]

[R²SiO_{3/2}] (2)

The constituent unit represented by Formula (2) above is a silsesquioxane constituent unit (T unit) generally represented by [RSiO_{3/2}]. That is, the constituent unit represented by Formula (2) above is formed by hydrolysis and condensation reactions of a corresponding hydrolyzable trifunctional silane compound (specifically, a compound represented by Formula (b) described later).

R² in Formula (2) represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. Examples of the aryl group include a phenyl group, a tolyl group, and a naphthyl group. Examples of the aralkyl group include a benzyl group and a phenethyl group. Examples of the cycloalkyl group include a cyclobutyl group, a cyclopentyl group, and a cyclohexyl group. Examples of the alkyl group include linear or branched alkyl groups, such as a methyl group, an ethyl group, a propyl group, an n-butyl group, an isopropyl group, an isobutyl group, an s-butyl group, a t-butyl group, and an isopentyl group. Examples of the alkenyl group include linear or branched alkenyl groups, such as a vinyl group, an allyl group, and an isopropenyl group.

Examples of the substituted aryl group, the substituted aralkyl group, the substituted cycloalkyl group, the substituted alkyl group, and the substituted alkenyl group described above include a group in which some or all of hydrogen atoms or a portion or whole of the backbone in each of the aryl group, the aralkyl group, the cycloalkyl group, the alkyl group, and the alkenyl group described above are substituted with at least one type selected from the group consisting of an ether group, an ester group, a carbonyl group, a siloxane group, a halogen atom (such as a fluorine atom), an acrylic group, a methacrylic group, a mercapto group, an amino group, and a hydroxy group (hydroxyl group).

Among them, R² is preferably a substituted or unsubstituted aryl group, a substituted or unsubstituted alkyl group, a substituted or unsubstituted alkenyl group, more preferably a substituted or unsubstituted aryl group, and even more preferably a phenyl group.

A ratio of each silsesquioxane constituent unit described above (the constituent unit represented by Formula (1) and the constituent unit represented by Formula (2)) in the polyorganosilsesquioxane can be appropriately adjusted by the composition of the raw materials (hydrolyzable trifunctional silanes) for forming these constituent units.

The polyorganosilsesquioxane may further include, in addition to the constituent unit represented by Formula (1) above and the constituent unit represented by Formula (2) above, at least one type of silsesquioxane constituent unit selected from the group consisting of a silsesquioxane constituent unit [RSiO_{3/2}] other than the constituent unit represented by Formula (1) above and the constituent unit represented by Formula (2) above: a constituent unit represented by [R₃SiO_{1/2}] (what is called an M unit); a constituent unit represented by [R₂SiO] (what is called a D unit); and a constituent unit represented by [SiO₂] (what is called a Q unit). Here, examples of the silsesquioxane constituent unit other than the constituent unit represented by Formula (1) above and the constituent unit represented by Formula (2) above include a constituent unit represented by Formula (3) below.

[Chem. 18]

[HSiO_{3/2}] (3)

The ratio of the constituent unit (T3 form) represented by Formula (I) above to the constituent unit (T2 form) represented by Formula (II) above [T3 form/T2 form] in the polyorganosilsesquioxane is 5 or greater as described above, preferably from 5 to 18, more preferably from 6 to 16, and even more preferably from 7 to 14. The above ratio [T3 form/T2 form] of 5 or greater significantly improves the surface hardness of the resulting hard coat layer.

The constituent unit represented by Formula (I) above is represented by Formula (I′) below in more detail. Furthermore, the constituent unit represented by Formula (II) above is represented by Formula (II′) below in more detail. Three oxygen atoms bonded to the silicon atom illustrated in the structure represented by Formula (I′) below are each bonded to another silicon atom (a silicon atom not illustrated in Formula (I′)). On the other hand, two oxygen atoms located above and below the silicon atom illustrated in the structure represented by Formula (II′) below are each bonded to another silicon atom (a silicon atom not illustrated in Formula (II′)). That is, both the T3 form and the T2 form are constituent units (T units) formed by hydrolysis and condensation reactions of a corresponding hydrolyzable trifunctional silane compound.

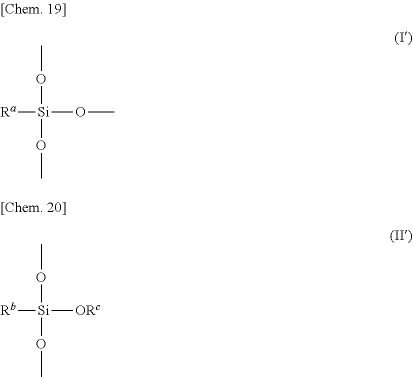

R^{a} in Formula (I) above (also R^{a} in Formula (I′)) and R^{b} in Formula (II) above (also R^{b} in Formula (II′)) each represent a group containing an epoxy group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom. Specific examples of R^{a} and R^{b} include the same for R¹ in Formula (1) above and R² in Formula (2) above. R^{a} in Formula (I) and R^{b} in Formula (II) are each derived from a group bonded to a silicon atom in the hydrolyzable trifunctional silane compound used as a raw material for the polyorganosilsesquioxane (a group other than an alkoxy group and a halogen atom; for example, R¹, R², a hydrogen atom, and the like in Formulae (a) to (c) described later).

R^{c} in Formula (II) above (also R^{c} in Formula (II′)) represents a hydrogen atom or an alkyl group having from 1 to 4 carbons. Examples of the alkyl group having from 1 to 4 carbons include linear or branched alkyl groups having from 1 to 4 carbons, such as a methyl group, an ethyl group, a propyl group, an isopropyl group, a butyl group, and an isobutyl group. The alkyl group in R^{c} in Formula (II) is typically derived from an alkyl group forming an alkoxy group (for example, an alkoxy group as X¹ to X³ described later) in the hydrolysable silane compound used as a raw material for the polyorganosilsesquioxane.

The above ratio [T3 form/T2 form] in the polyorganosilsesquioxane can be determined, for example, by ²⁹Si-NMR spectrum measurement. In the ²⁹Si-NMR spectrum, the silicon atom in the constituent unit (T3 form) represented by Formula (I) above and the silicon atom in the constituent unit (T2 form) represented by Formula (II) above exhibit signals (peaks) at different positions (chemical shifts), and thus the above ratio [T3 form/T2 form] is determined by calculating the integration ratio of these respective peaks. Specifically, for example, when the polyorganosilsesquioxane includes a constituent unit represented by Formula (I) above wherein R¹ is a 2-(3′,4′-epoxycyclohexyl)ethyl group, the signal of the silicon atom in the structure (T3 form) represented by Formula (I) above appears at −64 to −70 ppm, and the signal of the silicon atom in the structure (T2 form) represented by Formula (II) above appears at −54 to −60 ppm. Thus, in this case, the above ratio [T3 form/T2 form] can be determined by calculating the integration ratio of the signal at −64 to −70 ppm (T3 form) and the signal at −54 to −60 ppm (T2 form).

The ²⁹Si-NMR spectrum of the polyorganosilsesquioxane can be measured, for example, with the following instrument and conditions.

Measuring instrument: Trade name “JNM-ECA500NMR” (available from JEOL Ltd.)

Solvent: Deuteriochloroform

Cumulative number: 1800 times

Measurement temperature: 25° C.

The above ratio [T3 form/T2 form] of the polyorganosilsesquioxane of 5 or greater means that a certain amount or greater of T2 forms are present relative to T3 forms in the polyorganosilsesquioxane. Examples of such a T2 form include a constituent unit represented by Formula (4) below, a constituent unit represented by Formula (5) below, and a constituent unit represented by Formula (6) below. R¹ in Formula (4) below and R² in Formula (5) below are each the same as R¹ in Formula (1) above and R² in Formula (2) above. R^{c} in Formulas (4) to (6) below represents a hydrogen atom or an alkyl group having from 1 to 4 carbons, as in the case of R^{c} in Formula (II).

[Chem. 21]

[R¹SiO_{2/2}(OR^{c})] (4)

[Chem. 22]

[R²SiO_{2/2}(OR^{c})] (5)

[Chem. 23]

[HSiO_{2/2}(OR^{c})] (6)

Typically, a complete cage-type silsesquioxane is a polyorganosilsesquioxane constituted of a T3 form only, and no T2 form is present in the molecule. That is, the polyorganosilsesquioxane having the above ratio [T3 form/T2 form] of 5 or greater, a number average molecular weight of 1000 to 3000, and a molecular weight dispersity of from 1.0 to 3.0, and further having one inherent absorption peak at or near 1100 cm⁻¹ in an FT-IR spectrum as described later suggests the inclusion of an incomplete cage-type silsesquioxane structure.

The polyorganosilsesquioxane including a cage-type (incomplete cage-type) silsesquioxane structure is confirmed by an FT-IR spectrum in which the polyorganosilsesquioxane has no inherent absorption peaks at or near 1050 cm⁻¹ and 1150 cm⁻¹ each and has one inherent absorption peak at or near 1100 cm⁻¹ [Reference: R. H. Raney, M. Itoh, A. Sakakibara and T. Suzuki, Chem. Rev. 95, 1409 (1995)]. In contrast, the polyorganosilsesquioxane having inherent absorption peaks at or near 1050 cm⁻¹ and 1150 cm⁻¹ each in the FT-IR spectrum is typically identified as including a ladder-type silsesquioxane structure. The FT-IR spectrum of the polyorganosilsesquioxane can be measured, for example, with the following instrument and conditions.

Measuring instrument: Trade name “FT-720” (available from Horiba, Ltd.)

Measurement method: Transmission method

Resolution: 4 cm⁻¹

Measurement wavenumber range: from 400 to 4000 cm⁻¹

Cumulative number: 16 times

The ratio (total amount) of the constituent units represented by Formula (1) above and the constituent units represented by Formula (4) above relative to a total amount of siloxane constituent units [total siloxane constituent units; total amount of M unit, D unit, T unit, and Q unit] (100 mol %) in the polyorganosilsesquioxane is from 55 to 100 mol % as described above, preferably from 65 to 100 mol %, and more preferably from 80 to 99 mol %. The polyorganosilsesquioxane with the above ratio of 55 mol % or greater improves the curability of the curable composition and significantly increases the surface hardness of the hard coat layer. In addition, the ratio of each siloxane constituent unit in the polyorganosilsesquioxane can be calculated, for example, from a raw material composition, NMR spectrum measurement, or the like.

The ratio (total amount) of the constituent units represented by Formula (2) above and the constituent units represented by Formula (5) above relative to a total amount of siloxane constituent units [total siloxane constituent units; total amount of M unit, D unit, T unit, and Q unit] (100 mol %) in the polyorganosilsesquioxane is not particularly limited but is preferably from 0 to 70 mol %, more preferably from 0 to 60 mol %, even more preferably from 0 to 40 mol %, and particularly preferably from 1 to 15 mol %. The polyorganosilsesquioxane with the above ratio of 70 mol % or less can relatively increase the ratio of the constituent units represented by Formula (1) and the constituent units represented by Formula (4) and thus tends to improve the curability of the curable composition and further increase the surface hardness of the resulting hard coat layer. On the other hand, the polyorganosilsesquioxane with the above ratio of 1 mol % or greater tends to improve gas barrier properties of the resulting hard coat layer.

The ratio (total amount) of the constituent units represented by Formula (1) above, the constituent units represented by Formula (2) above, the constituent units represented by Formula (4) above, and the constituent units represented by Formula (5) above relative to a total amount of siloxane constituent units [total siloxane constituent units; total amount of M unit, D unit, T unit, and Q unit] (100 mol %) in the polyorganosilsesquioxane is not particularly limited but is preferably from 60 to 100 mol %, more preferably from 70 to 100 mol %, and even more preferably from 80 to 100 mol %. The polyorganosilsesquioxane with the above ratio of 60 mol % or greater tends to further increase the surface hardness of the resulting hard coat layer.

The number average molecular weight (Mn) of the polyorganosilsesquioxane in terms of standard polystyrene by gel permeation chromatography is from 1000 to 3000 as described above, preferably from 1000 to 2800, and more preferably from 1100 to 2600. The polyorganosilsesquioxane with a number average molecular weight of 1000 or higher further improves the heat resistance, scratch resistance, and adhesiveness of the cured product. On the other hand, the polyorganosilsesquioxane with a number average molecular weight of 3000 or lower improves compatibility with other components in the curable composition and further improves the heat resistance of the resulting hard coat layer.

The molecular weight dispersity (Mw/Mn) of the polyorganosilsesquioxane in terms of standard polystyrene by gel permeation chromatography is from 1.0 to 3.0 as described above, preferably from 1.1 to 2.0, and more preferably from 1.2 to 1.9. The polyorganosilsesquioxane with a molecular weight dispersity of 3.0 or less further increases the surface hardness of the resulting hard coat layer. On the other hand, the polyorganosilsesquioxane with a molecular weight dispersity of 1.0 or greater tends to easily become liquid and improve the handleability.

The number average molecular weight and the molecular weight dispersity of the polyorganosilsesquioxane can be measured with the following instruments and conditions.

Measuring instrument: Trade name “LC-20AD” (available from Shimadzu Corporation)

Column: Shodex KF-801×2, KF-802, and KF-803 (available from Showa Denko K.K.)

Measurement temperature: 40° C.

Eluent: THF, sample concentration of 0.1 to 0.2 wt. %

Flow rate: 1 mL/min

Detector: UV-VIS detector (trade name “SPD-20A”, available from

Shimadzu Corporation)

Molecular weight: in terms of standard polystyrene

A 5% weight loss temperature (T_{d5}) of the polyorganosilsesquioxane in air atmosphere is preferably 330° C. or higher (for example, from 330 to 450° C.), more preferably 340° C. or higher, and even more preferably 350° C. or higher. The polyorganosilsesquioxane with a 5% weight loss temperature of 330° C. or higher tends to further improve the heat resistance of the cured product. In particular, if the polyorganosilsesquioxane has the above ratio [T3 form/T2 form] of 5 or greater, the number average molecular weight of 1000 to 3000, the molecular weight dispersity of from 1.0 to 3.0, and one inherent peak at or near 1100 cm⁻¹ in the FT-IR spectrum, the 5% weight loss temperature thereof is controlled to be 330° C. or higher. Here, the 5% weight loss temperature is a temperature at which 5% of the weight before heating decreases when heated at a constant temperature increase rate, and is an indicator of heat resistance. The 5% weight loss temperature can be measured by TGA (thermogravimetric analysis) under conditions of a temperature increase rate of 5° C./min in air atmosphere.

The polyorganosilsesquioxane can be produced by a well-known or commonly used method for producing a polysiloxane and, for example, can be produced by a method of hydrolysis and condensation of one type or two or more types of hydrolyzable silane compounds. As the hydrolyzable silane compound, however, a hydrolyzable trifunctional silane compound (compound represented by Formula (a) below) for forming the constituent unit represented by the Formula (1) described above needs to be used as an essential hydrolyzable silane compound.

More specifically, for example, the polyorganosilsesquioxane can be produced by a method of hydrolysis and condensation of a compound represented by Formula (a) below, which is a hydrolyzable silane compound for forming a silsesquioxane constituent unit (T unit) in the polyorganosilsesquioxane, and additionally as necessary a compound represented by Formula (b) below and a compound represented by Formula (c) below.

[Chem. 24]

R¹Si(X¹)₃ (a)

[Chem. 25]

R²Si(X²)₃ (b)

[Chem. 26]

HSi(X³)₃ (c)

The compound represented by Formula (a) above is a compound that forms a constituent unit represented by Formula (1) in the polyorganosilsesquioxane. R¹ in Formula (a) represents a group containing an epoxy group, as in the case of R¹ in Formula (1) above. That is, R¹ in Formula (a) is preferably a group represented by Formula (1a) above, a group represented by Formula (1b) above, a group represented by Formula (1c) above, and a group represented by Formula (1d) above, more preferably a group represented by Formula (1a) above and a group represented by Formula (1c) above, even more preferably a group represented by Formula (1a) above, particularly preferably a group represented by Formula (1a) above wherein R^{1a} is an ethylene group (in particular, 2-(3′,4′-epoxycyclohexyl)ethyl group).

X¹ in Formula (a) above represents an alkoxy group or a halogen atom. Examples of the alkoxy group in X¹ include alkoxy groups having from 1 to 4 carbons, such as a methoxy group, an ethoxy group, a propoxy group, an isopropyloxy group, a butoxy group, and an isobutyloxy group. In addition, examples of the halogen atom in X¹ include a fluorine atom, a chlorine atom, a bromine atom, and an iodine atom. Among them, X¹ is preferably an alkoxy group, and more preferably a methoxy group and an ethoxy group. In addition, the three X's each may be the same or different.

The compound represented by Formula (b) above is a compound that forms a constituent unit represented by Formula (2) in the polyorganosilsesquioxane. R² in Formula (b) represents, as in the case of R² in Formula (2) above, a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. That is, R² in Formula (b) is preferably a substituted or unsubstituted aryl group, a substituted or unsubstituted alkyl group, a substituted or unsubstituted alkenyl group, more preferably a substituted or unsubstituted aryl group, and even more preferably a phenyl group.

X² in Formula (b) above represents an alkoxy group or a halogen atom. Specific examples of X² include those exemplified as X¹. Among them, X² is preferably an alkoxy group, and more preferably a methoxy group and an ethoxy group. In addition, the three X²s each may be the same or different.

The compound represented by Formula (c) above is a compound that forms a constituent unit represented by Formula (3) in the polyorganosilsesquioxane. X³ in Formula (c) above represents an alkoxy group or a halogen atom. Specific examples of X¹ include those exemplified as X¹. Among them, X³ is preferably an alkoxy group, and more preferably a methoxy group and an ethoxy group. In addition, the three X³s each may be the same or different.

A hydrolyzable silane compound other than the compounds represented by Formulae (a) to (c) above may be used in combination as the hydrolyzable silane compound. Examples thereof include hydrolyzable trifunctional silane compounds other than the compounds represented by Formulae (a) to (c) above, hydrolyzable monofunctional silane compounds forming an M unit, hydrolysable bifunctional silane compounds forming a D unit, and hydrolysable tetrafunctional silane compounds forming a Q unit.

The used amount and the composition of the hydrolyzable silane compound can be appropriately adjusted according to a desired structure of the polyorganosilsesquioxane. For example, the used amount of the compound represented by Formula (a) above is not particularly limited but is preferably from 55 to 100 mol %, more preferably from 65 to 100 mol %, and even more preferably from 80 to 99 mol %, relative to a total amount (100 mol %) of the hydrolyzable silane compound used.

In addition, the used amount of the compound represented by Formula (b) above is not particularly limited but is preferably from 0 to 70 mol %, more preferably from 0 to 60 mol %, even more preferably from 0 to 40 mol %, and particularly preferably from 1 to 15 mol %, relative to a total amount (100 mol %) of the hydrolyzable silane compound used.

Furthermore, the ratio (ratio of a total amount) of the compound represented by Formula (a) and the compound represented by Formula (b) relative to a total amount (100 mol %) of the hydrolysable silane compound used is preferably from 60 to 100 mol %, more preferably from 70 to 100 mol %, and even more preferably from 80 to 100 mol %.

In addition, in a case where two or more types of the hydrolyzable silane compounds are used in combination, hydrolysis and condensation reactions of these hydrolyzable silane compounds can be performed simultaneously or sequentially. The order of the reactions when performed sequentially is not particularly limited.

The hydrolysis and condensation reactions of the hydrolyzable silane compound can be performed in the presence or absence of a solvent. Among them, the hydrolysis and condensation reactions are preferably performed in the presence of a solvent. Examples of the solvent include aromatic hydrocarbons, such as benzene, toluene, xylene, and ethylbenzene; ethers, such as diethyl ether, dimethoxyethane, tetrahydrofuran, and dioxane: ketones, such as acetone, methyl ethyl ketone, and methyl isobutyl ketone; esters, such as methyl acetate, ethyl acetate, isopropyl acetate, and butyl acetate; amides, such as N,N-dimethylformamide and N,N-dimethylacetamide; nitriles, such as acetonitrile, propionitrile, and benzonitrile; alcohols, such as methanol, ethanol, isopropyl alcohol, and butanol. Among them, the solvent is preferably ketones and ethers. In addition, one type of the solvent can be used alone, or two or more types thereof can be used in combination.

The amount of the solvent used is not particularly limited and can be appropriately adjusted in a range of 0 to 2000 parts by weight relative to 100 parts by weight of a total amount of the hydrolyzable silane compound, according to a desired reaction time or the like.

The hydrolysis and condensation reactions of the hydrolyzable silane compound is preferably performed in the presence of a catalyst and water. The catalyst may be an acid catalyst or an alkali catalyst. Examples of the acid catalyst include mineral acids, such as hydrochloric acid, sulfuric acid, nitric acid, phosphoric acid, and boric acid; phosphate esters; carboxylic acids, such as acetic acid, formic acid, and trifluoroacetic acid: sulfonic acids, such as methanesulfonic acid, trifluoromethanesulfonic acid, and p-toluenesulfonic acid; solid acids, such as activated clay; and Lewis acids, such as iron chloride. Examples of the alkali catalyst include alkali metal hydroxides, such as lithium hydroxide, sodium hydroxide, potassium hydroxide, and cesium hydroxide: alkaline earth metal hydroxides, such as magnesium hydroxide, calcium hydroxide, and barium hydroxide; alkali metal carbonates, such as lithium carbonate, sodium carbonate, potassium carbonate, and cesium carbonate; alkaline earth metal carbonates, such as magnesium carbonate; alkali metal hydrogencarbonates, such as lithium hydrogencarbonate, sodium hydrogencarbonate, potassium hydrogencarbonate, and cesium hydrogencarbonate; alkali metal organic acid salts (for example, acetates), such as lithium acetate, sodium acetate, potassium acetate, and cesium acetate; alkaline earth metal organic acid salts (for example, acetates), such as magnesium acetate; alkali metal alkoxides, such as lithium methoxide, sodium methoxide, sodium ethoxide, sodium isopropoxide, potassium ethoxide, and potassium t-butoxide; alkali metal phenoxides, such as sodium phenoxide: amines (tertiary amines and the like), such as triethylamine, N-methylpiperidine, 1,8-diazabicyclo[5.4.0]undec-7-ene, and 1,5-diazabicyclo[4.3.0]non-5-ene; and nitrogen-containing heterocyclic aromatic compounds, such as pyridine, 2,2′-bipyridyl, and 1,10-phenanthroline. Here, one type of the catalyst can be used alone, or two or more types thereof can be used in combination. In addition, the catalyst can be used in a state of being dissolved or dispersed in water, a solvent, or the like.

The amount of the catalyst used is not particularly limited and can be appropriately adjusted in a range from 0.002 to 0.200 mol relative to totally 1 mol of the hydrolyzable silane compound.

The amount of water used during the hydrolysis and condensation reactions is not particularly limited and can be appropriately adjusted in a range from 0.5 to 20 mol relative to totally 1 mol of the hydrolyzable silane compound.

The method for adding water is not particularly limited, and a total amount (total used amount) of water to be used may be added at once or may be added sequentially. When water is added sequentially, it may be added continuously or intermittently.

For the reaction conditions for performing the hydrolysis and condensation reactions of the hydrolyzable silane compound, it is particularly important to select the reaction conditions to achieve the above ratio [T3 form/T2 form] of 5 or greater in the polyorganosilsesquioxane. The reaction temperatures of the hydrolysis and condensation reactions are not particularly limited but are preferably from 40 to 100° C. and more preferably from 45 to 80° C. By controlling the reaction temperature to the above range, the above ratio [T3 form/T2 form] tends to be more efficiently controlled to 5 or greater. In addition, the reaction times of the hydrolysis and condensation reactions are not particularly limited but are preferably from 0.1 to 10 hours and more preferably from 1.5 to 8 hours. Furthermore, the hydrolysis and condensation reactions can be performed under normal pressure or can be performed under increased pressure or reduced pressure. Here, an atmosphere for performing the hydrolysis and condensation reactions are not particularly limited. For example, it may be any of under an inert gas atmosphere, such as a nitrogen atmosphere and an argon atmosphere, or in the presence of oxygen, such as in the air. However, the hydrolysis and condensation reactions are preferably performed in an inert gas atmosphere.

Polyorganosilsesquioxane can be obtained by the hydrolysis and condensation reactions of the hydrolyzable silane compound. After completion of the hydrolysis and condensation reactions, the catalyst is preferably neutralized to prevent the ring-opening of the epoxy group. The polyorganosilsesquioxane may be separated and purified by a separation means, for example, such as water washing, acid washing, alkali washing, filtration, concentration, distillation, extraction, crystallization, recrystallization, and column chromatography, or a combined separation means thereof.

The content (blended amount) of the polyorganosilsesquioxane is preferably 70 wt. % or greater and less than 100 wt. %, more preferably from 80 to 99.8 wt. %, and even more preferably from 90 to 99.5 wt. %, relative to a total amount (100 wt. %) of the curable composition for forming the hard coat excluding the solvent. The curable composition for forming the hard coat containing the polyorganosilsesquioxane in an amount of 70 wt. % or greater tends to further improve the surface hardness and adhesiveness of the cured product. On the other hand, the curable composition for forming the hard coat containing the polyorganosilsesquioxane in an amount of less than 100 wt. % can contain the curing catalyst, thereby tending to allow the curing of the curable composition to more efficiently proceed.

The ratio of the polyorganosilsesquioxane relative to a total amount (100 wt. %) of cationically curable compounds is preferably from 70 to 100 wt. %, more preferably from 75 to 98 wt. %, and even more preferably from 80 to 95 wt. %. The polyorganosilsesquioxane contained in an amount of 70 wt. % or greater tends to further improve the surface hardness of the resulting hard coat layer.

The polyorganosilsesquioxane includes the configuration described above, and thus by curing the curable composition including the polyorganosilsesquioxane as an essential component, a hard coat layer having high surface hardness and heat resistance, and excellent flexibility and processability can be formed.

### Silica Particles Including Group Containing (Meth)Acryloyl Group on Surface

In an embodiment of the present invention, silica particles including a group containing a (meth)acryloyl group on the surface have a property of imparting recoatability and further improving the scratch resistance and surface hardness. An infinite number of hydroxyl groups (Si—OH groups) are present on the surface of the silica particles, and the silica particles improve the crosslink density of the polyorganosilsesquioxane after curing through a reaction of the hydroxyl groups and the polyorganosilsesquioxane during curing. Furthermore. (meth)acryloyl groups bind to each other in a plurality of the silica particles during curing, thereby improving the crosslink density after curing. The consequent improved crosslink density after curing results in improvement of the scratch resistance and the recoatability of the hard coat layer. In addition, it is conceivable that the silica particles include a (meth)acryloyl group on the surface thereof and thus can impart stability to the curable composition. The stability refers to the fact that, in the preparation stage of the curable composition before curing, the silica particles and the polyorganosilsesquioxane do not react, and the curable composition does not have markedly increased viscosity (not gel) or solidify. Use of ordinary silica particles (SiO₂ particles) having no functional group, such as a group containing a (meth)acryloyl group, on the surface poses a risk that the silica particles may aggregate with each other, resulting in gelling of the curable composition. The silica particles may include a functional group other than a (meth)acryloyl group (for example, silicone-modified groups). Here, the (meth)acryloyl group is a generic term for an acryloyl group (acrylic group) and a methacryloyl group (methacrylic group). In addition, in an embodiment of the present invention, the silica particles are included in the cationically curable compound.

The silica particles may be used in a dispersion liquid (dispersion) in a state of being dispersed in a well-known or commonly used typical dispersion medium, such as water and organic solvents. In addition, silica particles that is allowed to react with a silane coupling agent including a group containing a (meth)acryloyl group may be used as the silica particles. As the silica particles, for example, the trade names “BYK-LPX 22699”, “NANOBYK-3650”, “NANOBYK-3651”, and “NANOBYK-3652” (all available from BYK Japan KK) can be used.

The particle size of the silica particles is, for example, from 1 to 100 nm, preferably from 3 to 50 nm, and more preferably from 5 to 30 nm. The silica particles with a particle size within the above range can further improve the recoatability.

A ratio of the silica particles including a group containing a (meth)acryloyl group on the surface thereof in the curable composition for forming the hard coat layer is, for example, from 0.01 to 20 parts by weight, preferably from 0.05 to 15 parts by weight, more preferably from 0.01 to 10 parts by weight, and even more preferably from 0.2 to 5 parts by weight, relative to 100 parts by weight of the polyorganosilsesquioxane. The silica particles contained in a ratio of 0.01 parts by weight or greater can improve the surface appearance and impart sufficient recoatability to the hard coat layer. In addition, the silica particles contained in a ratio of 20 parts by weight or less can increase the surface hardness of the hard coat layer.

### Photocationic Polymerization Initiator

The curable composition for forming the hard coat layer preferably includes a photocationic polymerization initiator as a curing catalyst in terms of being able to shorten the curing time until the curable composition becomes tack free.

Well known or commonly used photocationic polymerization initiators can be used as the photocationic polymerization initiator, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion. One type alone or two or more types thereof in combination can be used.

Examples of the sulfonium salt include a triarylsulfonium salt, such as the trade name “HS-1PC” (available from San-Apro Ltd.), the trade name “LW-SI”(available from San-Apro Ltd.), a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthyldiphenylsulfonium salt, a tris(4-hydroxyphenyl)sulfonium salt, a diphenyl[4-(phenylthio)phenyl]sulfonium salt, a 4-(p-tolylthio)phenyldi-(p-phenyl)sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt: monoarylsulfonium salt, such as a phenylmethylbenzylsulfonium salt, a 4-hydroxyphenylmethylbenzylsulfonium salt, and a 4-methoxyphenylmethylbenzylsulfonium salt; and a trialkylsulfonium salt, such as a dimethylphenacylsulfonium salt, a phenacyltetrahydrothiophenium salt, and a dimethylbenzylsulfonium salt.

As the diphenyl [4-(phenylthio)phenyl]sulfonium salt, products commercially available, for example, under the trade names, such as “CPI-101A” (diphenyl[4-(phenylthio)phenyl]sulfonium hexafluoroantimonate 50% propylene carbonate solution, available from San-Apro Ltd.) and “CPI-100P” (diphenyl[4-(phenylthio)phenyl]sulfonium hexafluorophoshate 50% propylene carbonate solution, available from San-Apro Ltd.), can be used. In addition, as the triarylsulfonium salt, products commercially available, for example, under the trade name, such as “K1-S” (non-antimony triarylsulfonium salt, available from San-Apro Ltd.), may be used.

Examples of the iodonium salt include the trade name “UV9380C” (a bis(4-dodecylphenyl)iodonium=hexafluoroantimonate 45% alkyl glycidyl ether solution, available from Momentive Performance Materials Japan LLC), the trade name “RHODORSIL PHOTOINITIATOR 2074” (tetrakis(pentafluorophenyl)borate=[(1-methylethyl)phenyl](methylphenyl)iodonium, available from Rhodia Japan Ltd.), the trade name “WPI-124” (available from Wako Pure Chemical Industries. Ltd.), a diphenyliodonium salt, a di-p-tolyliodoniuim salt, a bis(4-dodecylphenyl)iodonium salt, and a bis(4-methoxyphenyl)iodonium salt.

Examples of the selenium salt include a triarylselenium salt, such as a triphenylselenium salt, a tri-p-tolylselenium salt, a tri-o-tolylselenium salt, a tris(4-methoxyphenyl)selenium salt, and a 1-naphthyldiphenylselenium salt: a diarylselenium salt, such as a diphenylphenacylselenium salt, a diphenylbenzylselenium salt, and a diphenylmethylselenium salt: a monoarylselenium salt, such as a phenvlmethylbenzylselenium salt; and a trialkylselenium salt, such as a dimethylphenacylselenium salt.

Examples of the ammonium salt include a tetra alkyl ammonium salt, such as a tetra methylammonium salt, an ethyltrimethylammonium salt, a diethyldimethylammonium salt, a triethylmethylammonium salt, a tetraethylammonium salt, a trimethyl-n-propylammonium salt, and a trimethyl-n-butylammonium salt; a pyrrolidium salt, such as an N,N-dimethylpyrrolidium salt and an N-ethyl-N-methylpyrrolidium salt; an imidazolinium salt, such as an N,N′-dimethylimidazolinium salt and an N,N′-diethylimidazolinium salt: a tetrahydropyrimidium salt, such as an N,N′-dimethyltetrahydropyrimidium salt and an N,N′-diethyltetrahydropyrimidium salt; a morpholinium salt, such as an N,N-dimethylmorpholinium salt and an N,N-diethylmorpholinium salt: a piperidinium salt, such as an N,N-dimethylpiperidinium salt and an N,N-diethylpiperidinium salt; a pyridinium salt, such as an N-methylpyridinium salt and an N-ethylpyridinium salt; an imidazolium salt, such as an N,N′-dimethylimidazolium salt: a quinolium salt, such as an N-methylquinolium salt; an isoquinolium salt, such as an N-methylisoquinolium salt: a thiazonium salt, such as a benzylbenzothiazonium salt; and an acrydium salt, such as a benzylacrydium salt.

Examples of the phosphonium salt include a tetraarylphosphonium salt, such as a tetraphenylphosphonium salt, a tetra-p-tolylphosphonium salt, and a tetrakis(2-methoxyphenyl)phosphonium salt; a triarylphosphonium salt, such as a triphenylbenzylphosphonium salt; and a tetraalkylphosphonium salt, such as a triethylbenzylphosphonium salt, a tributylbenzylphosphonium salt, a tetraethylphosphonium salt, a tetrabutylphosphonium salt, and a triethylphenacylphosphonium salt.

Examples of the salt of the transition metal complex ion include a salt of a chromium complex cation, such as (η5-cyclopentadienyl)(η6-toluene)Cr⁺ and (η5-cyclopentadienyl)(η6-xylene)Cr⁺; and a salt of an iron complex cation, such as (η5-cyclopentadienyl)(η6-toluene)Fe⁺ and (η5-cyclopentadienyl)(η6-xylene)Fe⁺.

Examples of the anion constituting the salt described above include SbF₆—, PF₆⁻, BF₄⁻, (CF₃CF₂)₃PF₃⁻, (CF₃CF₂CF₂)₃PF₃⁻, (C₆F₅)₄B⁻, (C₆F₅)₄Ga⁻, a sulfonate anion (such as a trifluoromethanesulfonate anion, a pentafluoroethanesulfonate anion, a nonafluorobutanesulfonate anion, a methanesulfonate anion, a benzenesulfonate anion, and a p-toluenesulfonate anion), (CF₃SO₂)₃C⁻, (CF₃SO₂)₂N⁻, a perhalogenate ion, a halogenated sulfonate ion, a sulfate ion, a carbonate ion, an aluminate ion, a hexafluorobismuthate ion, a carboxylate ion, an arylborate ion, a thiocyanate ion, and a nitrate ion.

The content (blended amount) of the photocationic polymerization initiator in the curable composition for forming the hard coat layer is preferably from 0.01 to 3.0 parts by weight, more preferably from 0.05 to 3.0 parts by weight, and even more preferably from 0.1 to 1.0 parts by weight (for example, from 0.3 to 1.0 parts by weight), relative to 100 parts by weight of the polyorganosilsesquioxane. The photocationic polymerization initiator contained in an amount of 0.01 parts by weight or greater can allow the curing reaction to efficiently and sufficiently proceed, tending to further improve the surface hardness of the resulting hard coat layer. On the other hand, the photocationic polymerization initiator contained in an amount of 3.0 parts by weight or less tends to further improve storage properties of the curable composition and prevent coloration of the resulting hard coat layer.

### Additional Cationically Curable Compound

The curable composition for forming the hard coat layer may further include a cationically curable compound other than the silica particles and the polyorganosilsesquioxane. The additional cationically curable compound is not particularly limited, and a well-known or commonly used cationically curable compound can be used. Examples thereof include an epoxy compound other than the polyorganosilsesquioxane (which may be referred to as an “additional epoxy compound”), an oxetane compound, and a vinyl ether compound. Here, one type of the additional cationically curable compound can be used alone in the curable composition for forming the hard coat layer, or two or more types thereof can be used in combination therein.

The additional epoxy compound is not particularly limited, and a well-known or commonly used compound including one or more epoxy groups (oxirane rings) in the molecule can be used. Examples thereof include alicyclic epoxy compounds (alicyclic epoxy resins), aromatic epoxy compounds (aromatic epoxy resins), and aliphatic epoxy compounds (aliphatic epoxy resins).

The alicyclic epoxy compound includes well known or commonly used compounds including one or more alicyclic rings and one or more epoxy groups in the molecule and is not particularly limited. Examples thereof include (1) a compound including an epoxy group (referred to as an “alicyclic epoxy group”) constituted of two adjacent carbon atoms and an oxygen atom that constitute an alicyclic ring in the molecule; (2) a compound in which an epoxy group is directly bonded to an alicyclic ring with a single bond; and (3) a compound including an alicyclic ring and a glycidyl ether group in the molecule (a glycidyl ether type epoxy compound).

Examples of the compound (1) including an alicyclic epoxy group in the molecule include a compound represented by Formula (i) below.

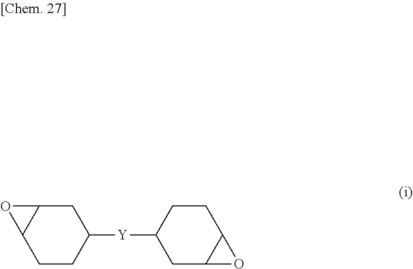

In Formula (i) above, Y represents a single bond or a linking group (a divalent group having one or more atoms). Examples of the linking group include divalent hydrocarbon groups, alkenylene groups in which some or all of the carbon-carbon double bonds are epoxidized, carbonyl groups, ether bonds, ester bonds, carbonate groups, amide groups, and groups in which a plurality thereof are linked.

Examples of the divalent hydrocarbon group include linear or branched alkylene groups having from 1 to 18 carbons and divalent alicyclic hydrocarbon groups. Examples of the linear or branched alkylene group having from 1 to 18 carbons include a methylene group, a methyl methylene group, a dimethyl methylene group, an ethylene group, a propylene group, and a trimethylene group. Examples of the divalent alicyclic hydrocarbon group include a divalent cycloalkylene group (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group in the alkenylene group in which some or all of the carbon-carbon double bonds are epoxidized (which may be referred to as an “epoxidized alkenylene group”) include a linear or branched alkenylene group having from 2 to 8 carbons, such as a vinylene group, a propenylene group, a 1-butenylene group, a 2-butenylene group, a butadienylene group, a pentenylene group, a hexenylene group, a heptenylene group, and an octenylene group. In particular, the epoxidized alkenylene group is preferably an alkenylene group in which all of the carbon-carbon double bonds are epoxidized, and more preferably an alkenylene group having from 2 to 4 carbons in which all of the carbon-carbon double bonds are epoxidized.

Representative examples of the alicyclic epoxy compound represented by Formula (i) above include 3,4,3′,4′-diepoxybicyclohexane and compounds represented by Formulae (i-1) to (i-10) below. In Formulae (i-5) and (i-7) below, 1 and m each represent an integer from 1 to 30. R¹ in Formula (i-5) below is an alkylene group having from 1 to 8 carbons, and, among them, a linear or branched alkylene group having from 1 to 3 carbons, such as a methylene group, an ethylene group, a propylene group, or an isopropylene group, is preferred. In Formulae (i-9) and (i-10) below, n1 to n6 each represent an integer from 1 to 30. In addition, examples of the alicyclic epoxy compound represented by Formula (i) above include 2,2-bis(3,4-epoxycyclohexyl)propane, 1,2-bis(3,4-epoxycyclohexyl)ethane, 2,3-bis(3,4-epoxycyclohexyl)oxirane, and bis(3,4-epoxycyclohexylmethyl)ether.

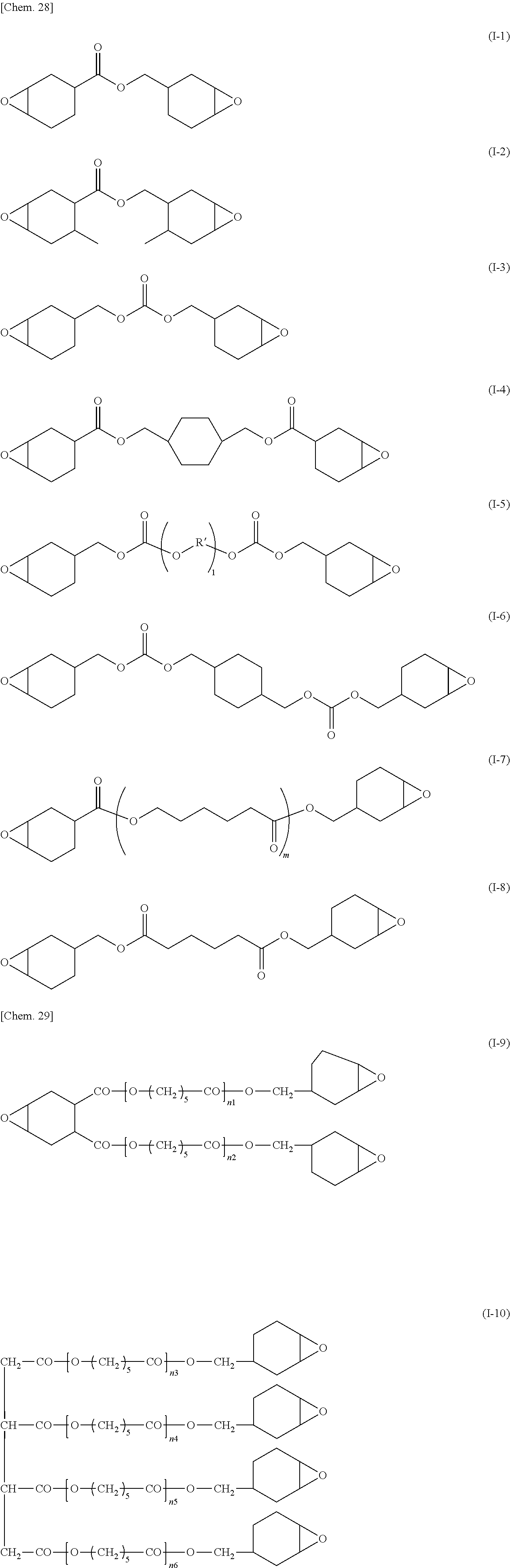

Examples of the compound (2) described above in which an epoxy group is directly bonded to an alicyclic ring with a single bond include a compound represented by Formula (ii) below.

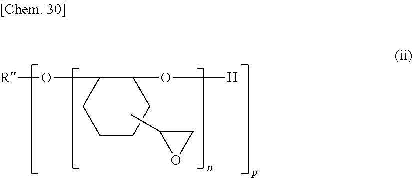

In Formula (ii), R″ is a group resulting from elimination of p hydroxyl groups (—OH) from a structural formula of a p-valent alcohol (p-valent organic group), wherein p and n each represent a natural number. Examples of the p-valent alcohol [R″(OH)ₚ] include polyhydric alcohols (alcohols having from 1 to 15 carbons), such as 2,2-bis(hydroxymethyl)-1-butanol. Here, p is preferably from 1 to 6, and n is preferably from 1 to 30. When p is 2 or greater, n in each group in parentheses (in the outer parentheses) may be the same or different. Examples of the compound represented by Formula (ii) specifically include 1,2-epoxy-4-(2-oxiranyl)cyclohexane adduct of 2,2-bis(hydroxymethyl)-1-butanol [for example, such as the trade name “EHPE3150” (available from Daicel Corporation)].

Examples of the compound (3) described above including an alicyclic ring and a glycidyl ether group in the molecule include glycidyl ethers of alicyclic alcohols (in particular, alicyclic polyhydric alcohols). More particularly, examples thereof include a compound obtained by hydrogenating a bisphenol A type epoxy compound (a hydrogenated bisphenol A type epoxy compound), such as 2,2-bis[4-(2,3-epoxypropoxy)cyclohexyl]propane and 2,2-bis[3,5-dimethyl-4-(2,3-epoxypropoxy)cyclohexyl]propane; a compound obtained by hydrogenating a bisphenol F type epoxy compound (a hydrogenated bisphenol F type epoxy compound), such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, and bis[3,5-dimethyl-4-(2,3-epoxypropoxy)cyclohexyl]methane; a hydrogenated bisphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; a hydrogenated epoxy compound of an epoxy compound obtained from trisphenolmethane; and a hydrogenated epoxy compound of an aromatic epoxy compound described below.

Examples of the aromatic epoxy compound include an epibis type glycidyl ether type epoxy resin obtained by a condensation reaction of bisphenols (for example, such as bisphenol A, bisphenol F, bisphenol S. and fluorenebisphenol) and an epihalohydrin; a high molecular weight epibis type glycidyl ether type epoxy resin obtained by further subjecting the above epibis type glycidyl ether type epoxy resin to an addition reaction with the bisphenol described above; a novolac alkyl type glycidyl ether type epoxy resin obtained by subjecting a phenol (for example, such as phenol, cresol, xylenol, resorcin, catechol, bisphenol A, bisphenol F, and bisphenol S) and an aldehyde (for example, such as formaldehyde, acetaldehyde, benzaldehyde, hydroxybenzaldehyde, and salicylaldehyde) to a condensation reaction to obtain a polyhydric alcohol, and then further subjecting the polyhydric alcohol to condensation reaction with epihalohydrin; and an epoxy compound in which two phenol skeletons are bonded at the 9-position of the fluorene ring, and glycidyl groups are each bonded directly or via an alkyleneoxy group to an oxygen atom resulting from eliminating a hydrogen atom from a hydroxy group of these phenol skeletons.

Examples of the aliphatic epoxy compound include glycidyl ethers of a q-valent alcohol, the alcohol including no cyclic structure (q is a natural number); glycidyl esters of monovalent or polyvalent carboxylic acids (for example, such as acetic acid, propionic acid, butyric acid, stearic acid, adipic acid, sebacic acid, maleic acid, and itaconic acid); epoxidized materials of fats and oils including a double bond, such as epoxidized linseed oil, epoxidized soybean oil, and epoxidized castor oil; and epoxidized materials of polyolefins (including polyalkadienes), such as epoxidized polybutadiene. Here, examples of the q-valent alcohol including no cyclic structure include monohydric alcohols, such as methanol, ethanol, 1-propyl alcohol, isopropyl alcohol, and 1-butanol: dihydric alcohols, such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and trihydric or higher polyhydric alcohols, such as glycerin, diglycerin, erythritol, trimethylolethane, trimethylolpropane, pentaerythritol, dipentaerythritol, and sorbitol. In addition, the q-valent alcohol may be polyether polyols, polyester polyols, polycarbonate polyols, polyolefin polyols, or the like.

The oxetane compound includes well known or commonly used compounds including one or more oxetane rings in the molecule and is not particularly limited. Examples thereof include 3,3-bis(vinyloxymethyl)oxetane, 3-ethyl-3-(hydroxymethyl)oxetane, 3-ethyl-3-(2-ethylhexyloxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis {[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis {[(3-ethyl-3-oxetanyl)methoxy]methyl}benzene, 3-ethyl-3-{[(3-ethyloxetane-3-yl)methoxy]methyl}oxetane, xylylenebisoxetane, 3-ethyl-3-{[3-(triethoxysilyl)propoxy]methyl}oxetane, oxetanylsilsesquioxane, and phenol novolac oxetane.

The vinyl ether compound is not particularly limited, and a well-known or commonly used compound including one or more vinyl ether groups in the molecule can be used. Examples thereof include 2-hydroxyethyl vinyl ether (ethyleneglycol monovinyl ether), 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,6-hexanediol divinyl ether, 1,8-octanediol divinyl ether, 1,4-cyclohexanedimethanol monovinyl ether, 1,4-cyclohexanedimethanol divinyl ether, 1,3-cyclohexanedimethanol monovinyl ether, 1,3-cyclohexanedimethanol divinyl ether, 1,2-cyclohexanedimethanol monovinyl ether, 1,2-cyclohexanedimethanol divinyl ether, p-xylene glycol monovinyl ether, p-xylene glycol divinyl ether, m-xylene glycol monovinyl ether, m-xylene glycol divinyl ether, o-xylene glycol monovinyl ether, o-xylene glycol divinyl ether, ethylene glycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, pentaethylene glycol monovinyl ether, pentaethylene glycol divinyl ether, oligoethylene glycol monovinyl ether, oligoethylene glycol divinyl ether, polyethylene glycol monovinyl ether, polyethylene glycol divinyl ether, dipropylene glycol monovinyl ether, dipropylene glycol divinyl ether, tripropylene glycol monovinyl ether, tripropylene glycol divinyl ether, tetrapropylene glycol monovinyl ether, tetrapropylene glycol divinyl ether, pentapropylene glycol monovinyl ether, pentapropylene glycol divinyl ether, oligopropyleneglycol monovinyl ether, oligopropyleneglycol divinyl ether, polypropyleneglycol monovinyl ether, polypropyleneglycol divinyl ether, isosorbide divinyl ether, oxanorbornene divinyl ether, phenyl vinyl ether, n-butyl vinyl ether, isobutyl vinyl ether, octyl vinyl ether, cyclohexyl vinyl ether, hydroquinone divinyl ether, 1,4-butanediol divinyl ether, cyclohexanedimethanol divinyl ether, trimethylolpropane divinyl ether, trimethylolpropane trivinyl ether, bisphenol A divinyl ether, bisphenol F divinyl ether, hydroxyoxanorbornanemethanol divinyl ether, 1,4-cyclohexanediol divinyl ether, pentaerythritol trivinyl ether, pentaerythritol tetravinyl ether, dipentaerythritol pentavinyl ether, and dipentaerythritol hexavinyl ether.

The content (blended amount) of the additional epoxy compound (in particular, the alicyclic epoxy compound) in the curable composition for forming the hard coat layer is not particularly limited but is preferably from 0.01 to 10 parts by weight, more preferably from 0.05 to 9 parts by weight, and even more preferably from 1 to 8 parts by weight, relative to a total amount of the polyorganosilsesquioxane and the additional cationically curable compound (100 parts by weight; a total amount of cationically curable compounds). Here, the polyorganosilsesquioxane is not included in the additional epoxy compound.

The content (blended amount) of the additional cationically curable compound in the curable composition for forming the hard coat layer is not particularly limited but is preferably 50 parts by weight or less (from 0 to 50 parts by weight), more preferably 30 parts by weight or less (from 0 to 30 parts by weight), and even more preferably 10 parts by weight or less, relative to a total amount of the polyorganosilsesquioxane and the additional cationically curable compound (100 parts by weight; a total amount of cationically curable compounds). The additional cationically curable compound contained in an amount of 50 wt. % or less (in particular, 10 wt. % or less) tends to improve the scratch resistance of the cured product. On the other hand, the additional cationically curable compound contained in an amount of 10 wt. % or greater can possibly impart a desired performance to the curable composition and the cured product (for example, fast curing properties and viscosity adjustment to the curable composition).

### Leveling Agent

The curable composition for forming the hard coat layer may include a leveling agent. Examples of the leveling agent include silicone-based leveling agents, fluorine-based leveling agents, and silicone-based leveling agents including a hydroxyl group.

Commercially available silicone-based leveling agents can be used as the silicone-based leveling agent. For example, products commercially available under the trade names “BYK-300”, “BYK-301/302”, “BYK-306”, “BYK-307”, “BYK-310”, “BYK-315”, “BYK-313”, “BYK-320”, “BYK-322”, “BYK-323”, “BYK-325”, “BYK-330”, “BYK-331”, “BYK-333”, “BYK-337”, “BYK-341”, “BYK-344”, “BYK-345/346”, “BYK-347”, “BYK-348”, “BYK-349”, “BYK-370”, “BYK-375”, “BYK-377”, “BYK-378”, “BYK-UV3500”, “BYK-UV3510”, “BYK-UV3570”, “BYK-3550”, “BYK-SILCLEAN3700”, and “BYK-SILCLEAN3720” (all above available from BYK Japan KK); the trade names “AC FS 180”, “AC FS 360”, and “AC S 20” (all above available from Algin Chemie); the trade names “POLYFLOW KL-400X”. “POLYFLOW KL-400HF”. “POLYFLOW KL-401”, “POLYFLOW KL-402”, “POLYFLOW KL-403”, and “POLYFLOW KL-404” (all above available from Kyoeisha Chemical Co., Ltd.): the trade names “KP-323”, “KP-326”, “KP-341”, “KP-104”, “KP-110”, and “KP-112” (all above available from Shin-Etsu Chemical Co., Ltd.); and the trade names “LP-7001”, “LP-7002”, “8032 ADDITIVE”, “57 ADDITIVE”, “L-7604”, “FZ-2110”, “FZ-2105”, “67 ADDITIVE”, “8618 ADDITIVE”, “3 ADDITIVE”, and “56 ADDITIVE” (all above available from Dow Corning Toray Co., Ltd.) can be used.

Commercially available fluorine-based leveling agents can be used as the fluorine-based leveling agent. For example, products commercially available under the trade names “Optool DSX” and “Optool DAC-HP” (all above available from Daikin Industries, Ltd.); the trade names “SURFLON S-242”, “SURFLON S-243”, “SURFLON S-420”, “SURFLON S-611”, “SURFLON S-651”, and “SURFLON S-386” (all above available from AGC Seimi Chemical Co., Ltd.): the trade name “BYK-340” (BYK Japan KK); the trade names “AC 110a” and “AC 100a” (all above available from Algin Chemie): the trade names “MEGAFAC F-114”, “MEGAFAC F-410”, “MEGAFAC F-444”, “MEGAFAC EXP TP-2066”, “MEGAFAC F-430”, “MEGAFAC F-472SF”, “MEGAFAC F-477”, “MEGAFAC F-552”, “MEGAFAC F-553”, “MEGAFAC F-554”, “MEGAFAC F-555”, “MEGAFAC R-94”, “MEGAFAC RS-72-K”, “MEGAFAC RS-75”, “MEGAFAC F-556”, “MEGAFAC EXP TF-1367”, “MEGAFAC EXP TF-1437”, “MEGAFAC F-558”, and “MEGAFAC EXP TF-1537” (all above available from DIC Corporation); the trade names “FC-4430” and “FC-4432” (all above available from Sumitomo 3M Ltd.); the trade names “FTERGENT 100”, “FTERGENT 100C”, “FTERGENT 110”, “FTERGENT 150”. “FTERGENT 150CH”. “FTERGENT A-K”, “FTERGENT 501”, “FTERGENT 250”, “FTERGENT 251”, “FTERGENT 222F”, “FTERGENT 208G”. “FTERGENT 300”, “FTERGENT 310”, and “FTERGENT 400SW” (all above available from Neos Corporation); and the trade names “PF-136A”, “PF-156A”. “PF-151N”, “PF-636”, “PF-6320”, “PF-656”, “PF-6520”, “PF-651”, “PF-652”, and “PF-3320” (all above available from Kitamura Chemicals Co., Ltd.) can be used.

Examples of the silicone-based leveling agent including a hydroxyl group include polyether modified polyorganosiloxanes obtained by introducing a polyether group into the main chain or the side chain of the polyorganosiloxane backbone (such as polydimethylsiloxanes); and polyester modified polyorganosiloxanes obtained by introducing a polyester group into the main chain or the side chain of the polyorganosiloxane backbone. In these leveling agents, the hydroxyl group may include a polyorganosiloxane backbone or may include a polyether group or a polyester group. Leveling agent products commercially available under the trade names, such as “BYK-370”, “BYK-SILCLEAN 3700”, and “BYK-SILCLEAN 3720”, can be used.

A ratio of the leveling agent is, for example, from 0.01 to 20 parts by weight, preferably from 0.05 to 15 parts by weight, more preferably from 0.01 to 10 parts by weight, and even more preferably from 0.2 to 5 parts by weight, relative to 100 parts by weight of the polyorganosilsesquioxane. The polyorganosilsesquioxane containing the leveling agent in a ratio less than these values poses a risk of decreasing the surface smoothness of the cured product, and the polyorganosilsesquioxane containing the leveling agent in a ratio greater than these values poses a risk of decreasing the surface hardness of the cured product.

### Others

The curable composition for forming the hard coat layer may further include a commonly used additive as an additional optional component, such as an inorganic filler, such as precipitated silica, wet silica, fumed silica, calcined silica, titanium oxide, alumina, glass, quartz, aluminosilicic acid, iron oxide, zinc oxide, calcium carbonate, carbon black, silicon carbide, silicon nitride, and boron nitride: an inorganic filler obtained by treating the above filler with an organosilicon compound, such as an organohalosilane, organoalkoxysilane, and organosilazane; an organic resin fine powder, such as a silicone resin, an epoxy resin, and a fluororesin: a filler, such as a conductive metal powder of silver, copper, or the like, a curing auxiliary, a solvent (such as an organic solvent), a stabilizer (such as an antioxidant, an ultraviolet absorber, a light-resistant stabilizer, a heat stabilizer, and a heavy metal inactivator), a flame retardant (such as a phosphorus-based flame retardant, a halogen-based flame retardant, and an inorganic flame retardant), a flame retardant auxiliary, a reinforcing material (such as an additional filler), a nucleating agent, a coupling agent (such as a silane coupling agent), a lubricant, a wax, a plasticizer, a releasing agent, an impact modifier, a hue modifier, a transparentizing agent, a rheology modifier (such as a fluidity modifier), a processability modifier, a colorant (such as a dye and a pigment), an antistatic agent, a dispersant, an antifoaming agent, a foaming preventing agent, a surface modifier (such as a slipping agent), a matting agent, an antifoaming agent, a foam inhibitor, a deforming agent, an antibacterial agent, a preservative, a viscosity modifier, a thickening agent, a photosensitizer, and a foaming agent. One type alone or two or more types of these additives in combination can be used.

### Preparation of Hard Coat Layer

The curable composition for forming the hard coat layer can be prepared by, but not particularly limited to, agitating and mixing each component described above at room temperature or under heating as necessary. Here, the curable composition can be used as a one-part composition, which contains each component mixed beforehand and is used as is, or alternatively, used as a multi-part (for example, two-part) composition of which two or more components having been separately stored are mixed for use in a predetermined ratio before use.

The curable composition for forming the hard coat layer is not particularly limited but is preferably a liquid at normal temperature (about 25° C.). More specifically, a liquid of the curable composition diluted with a solvent to 20% [in particular, a curable composition (solution) of methyl isobutyl ketone in a ratio of 20 wt. %] has a viscosity at 25° C. preferably from 300 to 20000 mPa·s, more preferably from 500 to 10000 mPa·s, and even more preferably from 1000 to 8000 mPa·s. The curable composition with the viscosity of 300 mPa·s or greater tends to further improve the heat resistance of the cured product. On the other hand, the curable composition with the viscosity of 20000 mPa·s or less facilitates the preparation and handling of the curable composition, and tends to less likely to leave residual bubbles in the cured product. Here, the viscosity of the curable composition is measured using a viscometer (trade name “MCR301”, available from Anton Paar GmbH) under conditions: a swing angle of 5%, frequency from 0.1 to 100 (U/s), and a temperature of 25° C.

The thickness of the hard coat layer in an embodiment of the present invention is, in terms of the surface hardness and the scratch resistance, for example, from 1 to 100 μm, preferably from 2 to 80 μm, more preferably from 3 to 60 μm, and even more preferably from 5 to 50 μm.

The hard coat layer in an embodiment of the present invention is obtained by allowing a polymerization reaction of the cationically curable compound in the curable composition for forming the hard coat layer to proceed to cure the curable composition. The curing method can be appropriately selected from well-known methods, and examples thereof include a method of irradiation with an active energy ray and/or heating. As the active energy ray, for example, any of an infrared ray, a visible ray, an ultraviolet ray, an X-ray, an electron beam, an α-ray, a β-ray, and a γ-ray can be used. Among them, an ultraviolet ray is preferred in terms of excellent handling.

The conditions for curing by irradiation with the active energy ray are not particularly limited and can be appropriately adjusted according to the type and energy of the active energy ray to be irradiated, the shape, size, and the like of the hard coat layer. In the case of irradiation with an ultraviolet ray, however, it is, for example, preferably approximately from 1 to 1000 mJ/cm². In addition, for example, a high-pressure mercury lamp, an ultra high-pressure mercury lamp, a xenon lamp, a carbon arc, a metal halide lamp, the sunlight, an LED lamp, a laser, and the like can be used for irradiation with the active energy ray. After irradiation with the active energy ray, the curing reaction can be further allowed to proceed by further subjecting to a heat treatment (annealing and aging).

The conditions for curing by heating are not particularly limited but are preferably from 30 to 200° C. and more preferably from 50 to 190° C. The curing time can be appropriately set.

In an embodiment of the present invention, to further improve the recoatability of the hard coat layer, a surface treatment, such as corona discharge treatment that modifies the surface by corona discharge irradiation, plasma discharge treatment, ozone exposure treatment, and excimer treatment, is preferably performed on the surface of the hard coat layer. Among them, corona discharge treatment is more preferred in terms of being able to easily improve the recoatability.

Corona discharge treatment is a treatment in which an uneven electric field is generated around a pointed electrode (needle electrode) to generate a discharge, thereby processing the hard coat layer surface. Plasma discharge treatment is a treatment in which positively and negatively charged particles activated by discharging in the atmosphere are generated to process the hard coat layer surface. Ozone exposure treatment is a treatment in which ozone is generated by ultraviolet irradiation using, for example, a low-pressure mercury lamp or the like in the presence of oxygen to process the hard coat layer surface. Excimer treatment is a treatment to process the hard coat layer surface by ultraviolet irradiation or laser irradiation using an excimer lamp in a vacuum state.

### Functional Layer

The functional layer is, for example, a functional layer having functions, such as scratch resistance, wear resistance, stain repellency (stain resistance), fingerprint resistance, and antireflective properties (low reflectivity). The functional layer is a typical well known or commonly used functional layer having the functions listed above used in a hard coat layer in a display device of a mobile phone, a smart phone, and the like. Examples of the material constituting the functional layer include acrylic-based materials, fluorine-based materials, and silicone-based materials.

The functional layer is not particularly limited but can be produced by curing a curable composition (curable composition for forming a functional layer) containing a UV curable compound, such as a urethane acrylate and an acrylate, and a leveling agent. The leveling agents listed for the above curable composition for forming the hard coat layer can be used as the leveling agent. Among the above leveling agents, a fluorine-based acrylate leveling agent or a fluorine-based leveling agent is preferably used to improve the stain repellency (stain resistance). A fluorine-based acrylate leveling agent under the trade name “KY-1203” (available from Shin-Etsu Chemical Co., Ltd.) can be used. A fluorine-based leveling agent under the trade name “MEGAFAC RS-55” (available from DIC Corporation) can be used. The curable composition for forming the functional layer may include, in addition to the above, a polymerization initiator, such as a radical polymerization initiator, or an additive. Examples of the additive include the additives listed for the above curable composition for forming the hard coat layer.

The thickness of the functional layer is, in terms of the scratch resistance, for example, from 0.1 to 50 μm, preferably from 0.5 to 30 μm, more preferably from 1 to 20 μm, and even more preferably from 2 to 10 μm.

The water contact angle of the functional layer is, for example, 60° or greater (for example, from 60 to 120°), preferably 70° or greater, more preferably 80° or greater, and even more preferably 900 or greater. The functional layer with a water contact angle of 60° or greater can sufficiently exhibit the function of stain repellency.

### Substrate

The substrate is not particularly limited, and a well-known or commonly used substrate can be used, such as a plastic substrate, a metal substrate, a ceramic substrate, a semiconductor substrate, a glass substrate, a paper substrate, a wood substrate (wooden substrate), and a substrate of which surface is a coated surface. Among them, a plastic substrate is preferred. The substrate may include a single layer configuration, or may include a multilayer (laminated) configuration, and the configuration (structure) thereof is not particularly limited.

The plastic material constituting the plastic substrate is not particularly limited. Examples thereof include various plastic materials, such as polyesters, such as polyethylene terephthalate (PET) and polyethylene naphthalate (PEN); polyimides; polycarbonates: polyamides; polyacetals; polyphenylene oxides; polyphenylene sulfides: polyethersulfones; polyetheretherketones: cyclic polyolefins, such as homopolymers of norbornene-based monomers (such as addition polymers and ring-opened polymers), copolymers of a norbornene-based monomer and an olefin-based monomer (such as cyclic olefin copolymers, such as addition polymers and ring-opened polymers), such as a copolymer of norbornene and ethylene, and derivatives thereof; vinyl-based polymers (for example, acrylic resins, such as polymethyl methacrylates (PMMA), polystyrenes, polyvinyl chlorides, and acrylonitrile-styrene-butadiene resins (ABS resins)): vinylidene polymers (for example, such as polyvinylidene chlorides); cellulose resins, such as triacetyl cellulose (TAC); epoxy resins: phenolic resins; melamine resins; urea resins; maleimide resins: and silicones. Here, the above plastic substrate may be constituted of only one type of plastic material or may be constituted of two or more types of plastic materials.

Among the above plastic substrates, when the object is to obtain a laminate having excellent transparency, a substrate having excellent transparency (transparent substrate) is preferably used, and more preferably a polyester film (in particular. PET and PEN), a cyclic polyolefin film, a polycarbonate film, a TAC film, or a PMMA film is used.

The substrate (in particular, the plastic substrate) may contain an additional additive as necessary, such as an antioxidant, an ultraviolet absorber, a light-resistant stabilizer, a thermal stabilizer, a crystal nucleating agent, a flame retardant, a flame retardant auxiliary, a filler, a plasticizer, an impact modifier, a reinforcing agent, a dispersant, an antistatic agent, a foaming agent, and an antibacterial agent. Here, one type of the additive can be used alone, or two or more types thereof can be used in combination.

A well-known or commonly used surface treatment such as roughening treatment, adhesion-facilitating treatment, antistatic treatment, sand blast treatment (sand mat treatment), corona discharge treatment, plasma treatment, chemical etching treatment, water mat treatment, flame treatment, acid treatment, alkali treatment, oxidation treatment, ultraviolet irradiation treatment, and silane coupling agent treatment may be applied to part or all of the surface of the substrate (in particular, the plastic substrate). Here, the plastic substrate may be an unstretched film or a stretched film (such as a uniaxially stretched film and a biaxially stretched film). In addition, a commercially available substrate can be also used as the substrate.

The thickness of the substrate is, for example, approximately from 1 to 1000 μm and preferably from 5 to 500 μm.

The thickness (total thickness) of the laminate according to an embodiment of the present invention is, for example, from 10 to 1000 μm, preferably from 15 to 800 μm, more preferably from 20 to 700 μm, and even more preferably from 30 to 500 μm.

The laminate according to an embodiment of the present invention has high adhesion between the hard coat layer and the functional layer. In the laminate according to an embodiment of the present invention, peeling does not occur at all or peeling is less than 10%, as evaluated by the cross-cut tape test according to JIS K5400-8.5.

The pencil hardness of the surface of the laminate according to an embodiment of the present invention is preferably H or greater, more preferably 2H or greater, even more preferably 3H or greater, particularly preferably 4H or greater, and most preferably 6H or greater. Here, the pencil hardness can be evaluated according to the method described in JIS K5600-5-4.

The scratch resistance of the surface of the laminate according to an embodiment of the present invention means no noticeable scratch even when a steel wool #0000 is reciprocally slid 100 times on the surface (to scratch) with a load of 1 kg/cm², for example.

The laminate according to an embodiment of the present invention also has excellent surface smoothness, and the arithmetic average roughness Rₐ in the method according to JIS B0601 is, for example, from 0.1 to 20 nm, preferably from 0.1 to 10 nm, and more preferably from 0.1 to 5 nm.

The laminate according to an embodiment of the present invention also has excellent surface slipperiness (stain repellency), and the water contact angle of the surface is, for example, 60° or greater (for example, from 60° to 1200), preferably 700 or greater, more preferably 80° or greater, and even more preferably 90° or greater. The surface with a water contact angle of 60° or greater has excellent slipperiness (stain repellency) and also excellent scratch resistance.

The haze of the laminate according to an embodiment of the present invention is not particularly limited but is preferably 1.5% or less and more preferably 1.0% or less. In addition, the lower limit of the haze is not particularly limited but is, for example, 0.1%. The laminate with a haze particularly of 1.0% or less tends to be suitable for use, for example, in applications requiring very high transparency (for example, such as a surface protective sheet of a display of a touch panel, or the like). The haze of the laminate according to an embodiment of the present invention can be easily controlled to the above range, for example, by using the transparent substrate described above as the substrate. Here, the haze can be measured according to JIS K7136.

The total light transmittance of the laminate according to an embodiment of the present invention is not particularly limited but is preferably 85% or greater, and more preferably 90% or greater. In addition, the upper limit of the total light transmittance is not particularly limited but is, for example, 99%. The laminate with a total light transmittance particularly of 90% or greater tends to be suitable for use, for example, in applications requiring very high transparency (for example, such as a surface protective sheet of a display of a touch panel, or the like). The total light transmittance of the laminate according to an embodiment of the present invention can be easily controlled to the above range, for example, by using the transparent substrate described above as the substrate. Here, the total light transmittance can be measured according to JIS K7361-1.

The laminate according to an embodiment of the present invention may include an additional layer (for example, such as an intermediate layer, a primer layer, and an adhesive layer), in addition to the substrate, the hard coat layer, and the functional layer. In addition, the hard coat layer and the functional layer may be formed on only part of the laminate or may be formed on the entire surface. In the laminate according to an embodiment of the present invention, a surface protective film may be used to protect the surface thereof and to facilitate the die cutting process. A well-known or commonly used surface protective film can be used as the surface protective film, and, for example, a film including an adhesive layer on the surface of the plastic film can be used.

The laminate according to an embodiment of the present invention can be used as a glass alternative material in various products or components thereof, or components of parts thereof. Examples of the above products include display devices, such as liquid crystal displays and organic EL displays, input devices, such as touch panels; solar cells; various household electric appliances; various electrical and electronic products; various electrical and electronic products of portable electronic terminals (for example, such as game devices, personal computers, tablets, smartphones, and mobile phones); and various optical devices and automobile parts (for example, automotive interior parts, such as instrument panels, center panels, and ceilings).

### Method for Producing Laminate

The laminate according to an embodiment of the present invention can be produced according to a well-known or commonly used method for producing a hard coat film, and the production method thereof is not particularly limited. The laminate according to an embodiment of the present invention can be produced, for example, by applying the curable composition for forming the hard coat layer onto at least one surface of the substrate, removing a solvent by drying as necessary, and then curing the curable composition (curable composition layer). The conditions for curing the curable composition are not particularly limited and can be appropriately selected from the conditions in the preparation of the hard coat layer described above.

The laminate according to an embodiment of the present invention is constituted of the hard coat layer formed from the curable composition for forming the hard coat layer that can form a cured product having excellent flexibility and processability, and thus the laminate according to an embodiment of the present invention can be produced by a roll-to-roll process. Production of the laminate according to an embodiment of the present invention by a roll-to-roll process can significantly increase the productivity thereof. The method for producing the laminate according to an embodiment of the present invention by a roll-to-roll process is not particularly limited and a well-known or commonly used production method by a roll-to-roll process can be adopted. The examples thereof include a method including the following as essential processes: feeding out a substrate wound in a roll form (Process A), applying a curable composition to at least one surface of the substrate fed out, then removing a solvent by drying as necessary, and then curing the curable composition to form a hard coat layer (Process B); and then winding the resulting laminate into a roll (Process C); and continuously carrying out these processes (Processes A to C). In addition, the method may include processes other than processes A to C.

Furthermore, the functional layer in the laminate according to an embodiment of the present invention can also be provided in the same manner as the hard coat layer described above. For example, the functional layer can be provided by applying a curable composition for forming the functional layer on a hard coat layer formed by the above method, removing a solvent by drying as necessary, and then curing the curable composition. In addition, the functional layer may be provided by a method, such as vapor deposition or sputtering, in addition to the above applying method.

### EXAMPLES

Hereinafter, the present invention will be described in more detail based on examples, but the present invention is not limited by these examples. Molecular weight of a product was measured with an Alliance HPLC system 2695 (available from Waters), a Refractive Index Detector 2414 (available from Waters), columns of Tskgel GMHHR-M×2 (available from Tosoh Corporation), a guard column of Tskgel guard column HIIHRL (available from Tosoh Corporation), a column oven of COLUMN HEATER U-620 (available from Sugai), a solvent of THF, and a measurement condition of 40° C. In addition, the ratio of T2 form and T3 form [T3 form/T2 form] in the product was measured by ²⁹Si-NMR spectrum measurement with JEOL ECA500 (500 MHz). The T_{d5} (5% weight loss temperature) of the product was measured by TGA (thermogravimetric analysis) under conditions of a temperature increase rate of 5° C./min in air atmosphere.

### Synthesis Example 1: Synthesis of Curable Resin A

To a 300-mL flask (reaction vessel) equipped with a thermometer, a stirrer, a reflux condenser, and a nitrogen inlet tube, 161.5 mmol (39.79 g) of 2-(3,4-epoxycyclohexyl)ethyltrimethoxysilane (hereinafter, referred to as “EMS”), 9 mmol (1.69 g) of phenyltrimethoxysilane (hereinafter, referred to as “PMS”), and 165.9 g of acetone were charged under a nitrogen stream, and the temperature was raised to 50° C. To the mixture thus obtained, 4.70 g of 5% potassium carbonate aqueous solution (1.7 mmol as potassium carbonate) was added dropwise over 5 minutes, and then 1700 mmol (30.60 g) of water was added dropwise over 20 minutes. Here, no significant temperature increase occurred during the drop-wise additions. Thereafter, a polycondensation reaction was performed under a nitrogen stream for 4 hours while maintaining the temperature at 50° C.

A product in the reaction solution after the polycondensation reaction was analyzed to reveal a number-average molecular weight of 1911 and a molecular weight dispersity of 1.47. A ratio of T2 form and T3 form [T3 form/T2 form] calculated from the ²⁹Si-NMR spectrum of the product was 10.3.

Thereafter, the reaction solution was cooled and washed with water until the lower layer liquid became neutral. The upper layer liquid was collected, and then the solvent was distilled off from the upper layer liquid under conditions of 1 mmHg and 40° C. to obtain a colorless transparent liquid product (epoxy group-containing polyorganosilsesquioxane). T_{d5} of the product was 370° C.

In addition, the FT-IR spectrum of the curable resin A (polyorganosilsesquioxane) obtained in Synthesis Example 1 was measured by the method described above to confirm that each had one inherent absorption peak at or near 1100 cm⁻¹.

### Example 1

### Preparation of Hard Coat Layer

A mixed solution containing 61.6 parts by weight of the curable resin A (polyorganosilsesquioxane) obtained in Synthesis Example 1, 6.9 parts by weight of a compound including an alicyclic epoxy group (trade name “EHPE3150” available from Daicel Corporation), 30 parts by weight of methy 1 isobutyl ketone (MIBK) (available from Kanto Chemical Co., Inc.). 1 part by weight of a photocationic polymerization initiator (trade name “CPI-210S”, available from San-Apro Ltd.), and 0.5 part by weight of a leveling agent including an acrylic functional group on the surface of silica particles (trade name “BYK-LPX 22699”, available from BYK Japan KK) was prepared and used as a curable composition for forming a hard coat layer.

The curable composition for forming the hard coat layer obtained above was cast-coated on a PEN (polyethylene naphthalate) film (trade name “TEONEX” (trademark), available from Teijin DuPont Films Co., Ltd., thickness of 50 μm) using a wire bar #44 to give 20 μm thickness of the hard coat layer after curing, then the coated film was allowed to stand in an oven at 80° C. for 1 minute (pre-baked), and then irradiated with an ultraviolet ray for 5 seconds (ultraviolet irradiation dose: 400 mJ/cm²). Finally, the coated film was heat-treated at 150° C. for 30 minutes (aging) to prepare a substrate including a hard coat layer (hard coat layer/substrate).

### Corona Treatment to Hard Coat Layer

In the present example, corona (discharge) treatment to the hard coat layer was performed under the following conditions. In addition, the surface wettability after the corona treatment was adjusted at 42 dyn or greater.

Corona treatment environment: room temperature in air atmosphere

Output of high frequency power source: 0.2 kW

Distance between the film (the substrate including the hard coat layer) and a corona generation site: 2 mm

Number of treatments: 4 times

### Preparation of Functional Layer

In 30 parts by weight of methyl ethyl ketone (MEK), 28.4 parts by weight of acrylate monomer (trade name “UA-1100H”, available from Shin-Nakamura Chemical Co., Ltd.), 0.3 part by weight of a cyclic polymerizable monomer (trade name “FX-AO-MA”, available from Nippon Shokubai Co., Ltd.), 0.3 part by weight of CAP (cellulose acetate propionate), trade name “CAP-482-20”, available from Eastman Chemical Japan Co., Ltd.), 0.1 part by weight of a fluorine-based acrylate additive (trade name “KY-1203”, available from Shin-Etsu Chemical Co., Ltd.), 0.1 part by weight of a fluorine-based additive (trade name “MEGAFAC RS-55”, available from DIC Corporation), 0.6 part by weight of 1-hydroxy-cyclohexyl-phenyl-ketone (trade name “Irgacure 184”, available from BASF) as a photopolymerization initiator, and 0.3 part by weight of 2-methyl-1-(4-methylthiophenyl)-2-morpholinopropane-1-on (trade name “Irgacure 907”, available from BASF) as a photopolymerization initiator were dissolved, and this was used as a curable composition for forming a functional layer.

This curable composition for forming the functional layer was cast-coated on the hard coat layer obtained above using a wire bar #14 to give 5 μm thickness of the functional layer after curing, then the coated layer was allowed to stand in an oven at 70° C. for 1 minute (pre-baked), and then irradiated with an ultraviolet ray for 5 seconds (ultraviolet irradiation dose: 120 mJ/cm²). A laminate (functional layer/hard coat layer/substrate) was thereby produced.

### Examples 2 and 3, and Comparative Examples 1 to 7

A curable composition for forming a hard coat layer was prepared to make a hard coat layer in the same manner as in Example 1 except for changing the composition of the curable composition for forming the hard coat layer and the thickness of the hard coat layer as shown in Table 1, and a functional layer was laminated on the hard coat layer to make a laminate in the same manner as in Example 1. The presence or absence of corona treatment to the hard coat layer is as shown in Table 1. “SURFLON S-243” in leveling agent in curable composition for forming hard coat layer in Table 1 is an ethylene oxide adduct of a fluorine compound, the trade name “SURFLON S-243” (available from AGC Seimi Chemical Co., Ltd.). In addition, “KRM8479” in silicone acrylate in curable composition for forming hard coat layer in Table 1 is the trade name “KRM8479” (available from Daicel-Allnex Ltd.). “MEK-ST” for silica particles is the trade name “MEK-ST” (available from Nissan Chemical Corporation) and silica particles including no group containing a (meth)acryloyl group. In addition, the unit of the blended amounts of the raw materials of the curable compositions described in Table 1 are parts by weight.

### Evaluation

Various evaluations were performed on the laminates of Examples 1 to 3 and Comparative Examples 1 to 6 obtained above by the following methods. The results are shown in Table 1. In Comparative Example 7, the curable composition gelled, and thus the hard coat layer could not be made. Thus, Comparative Example 7 was not evaluated.

### Adhesion: Cross-Cut Method

The adhesion of the laminate (adhesion between the functional layer and the hard coat layer) was evaluated by the cross-cut tape test after cross-cutting according to JIS K5400-8.5. In the evaluation, the tape test was performed by cutting 100 squares with a cutter knife in arbitrary positions on the surface of the laminate and evaluated as follows according to the number of squares that are not peeled off by the tape test. In this connection, in Table 1, for example, when 100 squares out of 100 squares were not peeled off, the result was described as (100/100).

Good (Adhesion was good): No square out of 100 squares was peeled off

Poor (Adhesion was poor): One or more squares out of 100 squares were peeled off

### Appearance

The surface of the laminate was visually observed under fluorescent light to evaluate the appearance.

Good (Appearance was good): The surface had no distortion or unevenness thereon

Poor (Appearance was poor): Distortion or unevenness was observed on the surface

### Stain Repellency: Water Contact Angle

The water contact angle of the surface of the functional layer of the laminate obtained above was measured (sessile drop method) to evaluate the stain repellency according to the following criteria.

Good (Stain repellency was good): Water contact angle was 90° or greater

Poor (Stain repellency was poor): Water contact angle was less than 90°

### Pencil Hardness

The pencil hardness of the surface of the laminate obtained above was evaluated according to JIS K5600-5-4, with a load of 750 g.

### Scratch Resistance

A #0000 steel wool was reciprocated on the surface of the laminate obtained above a predetermined number of times described in Table 1 with a load of 1000 g/cm². The presence or absence of a scratch on the surface was checked every 100 times to evaluate the scratch resistance.

OK: No scratch was observed at a predetermined number of times

NG: A scratch was observed at a predetermined number of times

TABLE 1

| | | | Comparative | Comparative | Comparative | Comparative | Comparative |
|---|---|---|---|---|---|---|---|
| | | | Example 1 | Example 2 | Example 3 | Example 4 | Example 5 |
| Curable | Polyorganosilsesquioxane | Curable | 61.6 | 62.1 | 61.6 | 61.6 | 62.1 |
| composition | | resin A | | | | | |
| for forming | Epoxy compound | EHPE3150 | 6.9 | 6.9 | 6.9 | 6.9 | 6.9 |
| hard coat | Silica particles including | BYK-LPX | | | | | |
| layer | a (meth)acryloyl group | 22699 | | | | | |
| | on surface | | | | | | |
| | Silica particles | MEK-ST | | | | | |
| | Photocationic | CPI-210S | 1 | 1 | 1 | 1 | 1 |
| | polymerization initiator | | | | | | |
| | Leveling agent | SURFLON | 0.5 | | | 0.5 | |
| | | S-243 | | | | | |
| | Silicone acrylate | KRM8479 | | | 0.5 | | |
| | Solvent | MIBK | 30 | 30 | 30 | 30 | 30 |
| Hard coat | Thickness (μm) | | 20 | 20 | 20 | 20 | 20 |
| layer | Corona treatment | | None | None | None | Yes | Yes |
| Evaluation | Adhesion: Cross cut method | | Poor | Poor | Poor | Poor | Poor |
| | | | (0/100) | (10/100) | (0/100) | (10/100) | (10/100) |
| | Appearance | | Good | Poor | Good | Good | Poor |
| | Stain repellency (water contact | | Good | Good. | Good | Good | Good |
| | angle) | | (105°) | (105°) | (105°) | (105°) | (105°) |
| | Pencil hardness (load of 750 g) | | 7B or less | 7B or less | 7B or less | 7B or less | 7B or less |
| | Scratch resistance (load of 1 kg/cm²) | | NG at 100 | NG at 100 | NG at 100 | NG at 100 | NG at 100 |
| | | | times | times | times | times | times |
| | | | Comparative | Comparative | Example | Example | Example |
| | | | Example 6 | Example 7 | 1 | 2 | 3 |
| Curable | Polyorganosilsesquioxane | Curable | 61.6 | 61.6 | 61.6 | 61.6 | 61.6 |
| composition | | resin A | | | | | |
| for forming | Epoxy compound | EHPE3150 | 6.9 | 6.9 | 6.9 | 6.9 | 6.9 |
| hard coat | Silica particles including | BYK-LPX | | | 0.50 | 0.50 | 0.50 |
| layer | a (meth)acryloyl group | 22699 | | | | | |
| | on surface | | | | | | |
| | Silica particles | MEK-ST | | 0.50 | | | |
| | Photocationic | CPI-210S | 1 | 1 | 1 | 1 | 1 |
| | polymerization initiator | | | | | | |
| | Leveling agent | SURFLON | | | | | |
| | | S-243 | | | | | |
| | Silicone acrylate | KRM8479 | 0.5 | | | | |
| | Solvent | MIBK | 30 | 30 | 30 | 30 | 30 |

| | | | | | | |
|---|---|---|---|---|---|---|
| Hard coat | Thickness (μm) | 20 | — | 20 | 40 | 40 |
| layer | Corona treatment | Yes | | Yes | Yes | None |
| Evaluation | Adhesion: Cross cut method | Poor | (The curable | Good | Good | Good |
| | | (10/100) | composition | (100/100) | (100/100) | (100/100) |
| | Appearance | Good | gelled) | Good | Good | Good |
| | Stain repellency (water contact | Good | | Good | Good. | Good |
| | angle) | (105°) | | (105°) | (105°) | (105°) |
| | Pencil hardness (load of 750 g) | 7B or less | | 6H | 9H | 9H |
| | | NG at 100 | | OK at | OK at | OK at |
| | Scratch resistance (load of 1 kg/cm²) | times | | 1000 | 1000 | 1000 |
| | | | | times | times | times |

To summarize the above, configurations according to an embodiment of the present invention and variations thereof will be described below.

[1] A laminate including a laminated portion constituted of two or more layers including a hard coat layer and a functional layer in contact with the hard coat layer, and a substrate in contact with the hard coat layer, the functional layer being the outermost surface of the laminate; wherein the hard coat layer is a cured product layer of a curable composition containing a polyorganosilsesquioxane described below and silica particles, the silica particles including a group containing a (meth)acryloyl group on the surface;

the polyorganosilsesquioxane including a constituent unit represented by Formula (1); wherein a molar ratio of constituent units represented by Formula (I) (T3 form) to constituent units represented by Formula (II) (T2 form) is 5 or greater: a ratio (total amount) of constituent units represented by Formula (1) and constituent units represented by Formula (4) relative to a total amount of siloxane constituent units is from 55 to 100 mol %; a number average molecular weight is from 1000 to 3000; and a molecular weight dispersity is from 1.0 to 3.0.

[2] The laminate according to [1], wherein the polyorganosilsesquioxane further includes a constituent unit represented by Formula (2).

[3] The laminate according to [1] or [2], wherein, in the polyorganosilsesquioxane, R¹ in Formula (I) and Formula (4) is a group represented by Formula (1a), a group represented by Formula (1 b), a group represented by Formula (1c), or a group represented by Formula (1d).

[4] The laminate according to [2] or [3], wherein, the polyorganosilsesquioxane is a polyorganosilsesquioxane wherein R² in Formula (2) is a substituted or unsubstituted aryl group (preferably a phenyl group).

[5] The laminate according to any one of [1] to [4], including a constituent unit represented by Formula (5) as the constituent unit represented by Formula (II) above (T2 form).

[6] The laminate according to any one of [1] to [5], wherein a ratio (total amount) of constituent units represented by Formula (2) and constituent units represented by Formula (5) relative to a total amount of siloxane constituent units in the polyorganosilsesquioxane is from 0 to 70 mol %.

[7] The laminate according to any one of [1] to [6], wherein a ratio (total amount) of constituent units represented by Formula (I), constituent units represented by Formula (2), constituent units represented by Formula (4), and constituent units represented by Formula (5) is from 60 to 100 mol %.

[8] The laminate according to any one of [1] to [7], wherein a 5% weight loss temperature (T_{d5}) of the polyorganosilsesquioxane in air atmosphere is 330° C. or higher.

[9] The laminate according to any one of [1] to [8], wherein a content of the polyorganosilsesquioxane is 70 wt. % or greater relative to a total amount of the curable composition excluding a solvent.

[10] The laminate according to any one of [1] to [9], wherein a particle size of the silica particles is from 1 to 100 nm.

[11] The laminate according to any one of [1] to [10], wherein a ratio of the silica particles is from 0.01 to 20 parts by weight relative to 100 parts by weight of the polyorganosilsesquioxane.

[12] The laminate according to any one of [1] to [11], wherein the curable composition includes an additional cationically curable compound other than the silica particles and the polyorganosilsesquioxane.

[13] The laminate according to any one of [1] to [12], wherein the curable composition includes an epoxy compound (additional epoxy compound) other than the polyorganosilsesquioxane.

[14] The laminate according to [13], wherein the epoxy compound is at least one selected from the group consisting of an alicyclic epoxy compound, an aromatic epoxy compound, and an aliphatic epoxy compound.

[15] The laminate according to [14], wherein the alicyclic epoxy compound is at least one selected from the group consisting of a compound including an epoxy group constituted of two adjacent carbon atoms and an oxygen atom that constitute an alicyclic ring in the molecule: a compound in which an epoxy group is directly bonded to an alicyclic ring with a single bond; and a compound including an alicyclic ring and a glycidyl ether group in the molecule.

[16] The laminate according to [15], wherein the compound in which an epoxy group is directly bonded to the alicyclic ring with a single bond is a compound represented by Formula (ii).

[17] The laminate according to any one of [1] to [16], wherein a ratio of the polyorganosilsesquioxane relative to a total amount of cationically curable compounds is from 70 to 100 wt. %.

[18] The laminate according to any one of [13] to [17], wherein a content of the epoxy compound (in particular, the alicyclic epoxy compound) is from 0.01 to 10 wt. % relative to a total amount of the polyorganosilsesquioxane and the additional cationically curable compound.

[19] The laminate according to any one of [1] to [181, wherein the curable composition includes a photocationic polymerization initiator.

[20] The laminate according to [19], wherein the photocationic polymerization initiator is at least one selected from the group consisting of a sulfonium salt, an iodonium salt, a selenium salt, an ammonium salt, and a phosphonium salt.

[21] The laminate according to [19] or [20], wherein a content of the photocationic polymerization initiator is from 0.01 to 3.0 parts by weight relative to 100 parts by weight of the polyorganosilsesquioxane.

[22] The laminate according to any one of [1] to [21], wherein the curable composition includes a leveling agent (such as a silicone-based leveling agent, a fluorine-based leveling agent, and a silicone-based leveling agent including a hydroxyl group).

[23] The laminate according to [22], wherein a ratio of the leveling agent is from 0.01 to 20 parts by weight relative to 100 parts by weight of the polyorganosilsesquioxane.

[24] The laminate according to any one of [1] to [23], wherein a thickness of the hard coat layer is from 1 to 100 μm.

[25] The laminate according to any one of [1] to [24], wherein a thickness of the functional layer is from 0.1 to 50 μm.

[26] The laminate according to any one of [1] to [25], wherein the substrate is a plastic substrate, a metal substrate, a ceramic substrate, a semiconductor substrate, a glass substrate, a paper substrate, a wood substrate, or a substrate of which surface is a coated surface.

[27] The laminate according to any one of [1] to [26], wherein a total thickness is from 10 to 1000 μm.

### INDUSTRIAL APPLICABILITY

The laminate according to an embodiment of the present invention can be used as an alternative material of glass in various products, such as a display device, such as a liquid crystal display and an organic EL display, or components thereof, or components of parts thereof.

### REFERENCE SIGNS LIST

1 Laminate
2 Hard coat layer
3 Functional layer
4 Laminated portion
5 Substrate

1. A laminate comprising a laminated portion constituted of two or more layers comprising a hard coat layer and a functional layer in contact with the hard coat layer, and a substrate in contact with the hard coat layer, the functional layer being the outermost surface of the laminate;
wherein the hard coat layer is a cured product layer of a curable composition containing a polyorganosilsesquioxane described below and silica particles, the silica particles comprising a group containing a (meth)acryloyl group on the surface;
the polyorganosilsesquioxane comprise a constituent unit represented by Formula (1);
a molar ratio of constituent units represented by Formula (I) to constituent units represented by Formula (II), constituent units represented by Formula (I)/constituent units represented by Formula (II), is 5 or greater;
a ratio of constituent units represented by Formula (1) and constituent units represented by Formula (4) relative to a total amount of siloxane constituent units (100 mol %) is from 55 to 100 mol %;
a number average molecular weight is from 1000 to 3000; and
a molecular weight dispersity, weight average molecular weight/number average molecular weight, is from 1.0 to 3.0;
[R¹SiO_{3/2}] (1)
in Formula (1), R¹ represents a group containing an epoxy group;
[R^{a}SiO_{3/2}] (I)
in Formula (I), R^{a} represents a group containing an epoxy group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom;
[R^{b}SiO_{2/2}(OR^{c})] (II)
in Formula (II), R^{b} represents a group containing an epoxy group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; and R^{c} represents a hydrogen atom or an alkyl group having from 1 to 4 carbons; and
[R¹SiO_{2/2}(OR^{c})] (4)
in Formula (4), R¹ is the same as in Formula (I); and R^{c} is the same as in Formula (II).

2. The laminate according to claim 1, wherein the polyorganosilsesquioxane further comprises a constituent unit represented by Formula (2):
[R²SiO_{3/2}] (2)
in Formula (2), R² represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group.

3. The laminate according to claim 1, wherein
the polyorganosilsesquioxane is a polyorganosilsesquioxane, where R¹ is a group represented by Formula (1a), a group represented by Formula (1b), a group represented by Formula (1c), or a group represented by Formula (1d): 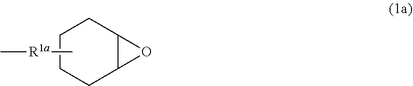
in Formula (1a), R^{1a} represents a linear or branched alkylene group; 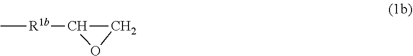
in Formula (1b), R^{1b} represents a linear or branched alkylene group; 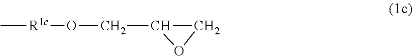
in Formula (1c), R^{1c} represents a linear or branched alkylene group; and 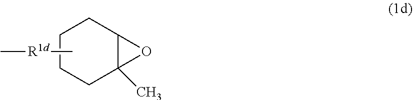
in Formula (1d), R^{1d} represents a linear or branched alkylene group.

4. The laminate according to claim 2, wherein, the polyorganosilsesquioxane is a polyorganosilsesquioxane wherein R² is a substituted or unsubstituted aryl group.

5. The laminate according to claim 1, wherein the curable composition comprises an epoxy compound other than the polyorganosilsesquioxane.

6. The laminate according to claim 1, wherein the curable composition comprises a photocationic polymerization initiator.

7. The laminate according to claim 1, wherein a thickness of the hard coat layer is from 1 to 100 μm.

8. The laminate according to claim 1, wherein a thickness of the functional layer is from 0.1 to 50 μm.

9. The laminate according to claim 1, wherein a total thickness is from 10 to 1000 μm.
